(19) United States
(12) Patent Application Publication
(10) Pub. No.: US 2026/0141550 A1
(43) Pub. Date: May 21, 2026

(54) DEPTH IMAGE ANALYSIS AND CORRECTION FOR MACHINE LEARNING SYSTEMS AND APPLICATIONS

(71) Applicant: NVIDIA Corporation, Santa Clara, CA (US)

(72) Inventor: Jack Yusong ZHANG, San Jose, CA (US)

(21) Appl. No.: 18/952,704

(22) Filed: Nov. 19, 2024

(51) Int. Cl. G06T 7/593; G06T 7/11; G06T 7/60; G06V 10/764

(52) U.S. Cl. CPC G06T 7/593; G06T 7/11; G06T 7/60; G06V 10/764; G06T 2207/20081; G06T 2207/30168

(57) ABSTRACT

In various examples, depth image analysis and correction for stereo image machine learning systems and applications are provided. A depth image anomaly identification stage of a depth image anomaly processor may perform functions for evaluating a depth image to identify anomalous segments where the values of pixels predicted by a stereo depth perception model appear anomalous with respect to accuracy in comparison with other regions of the depth image. A correction stage adjusts the depth image based on the identified anomalous segments using one or more correction techniques that may compute estimates or predictions for depth values within identified anomalous segments. Correction may be based on detected structural characteristics within the volume of space corresponding to the identified anomalous segments, and/or based on characteristics of local phenomena (e.g., lighting, reflections, glare, etc.) identified as potentially causing the inaccuracies in depth values.

### BACKGROUND

The representation of three-dimensional (3D) information in a scene is often captured as a depth or disparity image. A depth or disparity image is substantially similar to a traditional two-dimensional (2D) color raster image except that each pixel of a depth image represents information about a depth (e.g., a depth to an object) allowing for the reconstruction of the scene's 3D geometry. Stereo vision techniques, Time-of-Flight (ToF) cameras, structured light projection techniques, and Light Detection and Ranging (LiDAR) systems are each technologies that may be used to collect depth information from a scene. Depth information can be used in various applications such as 3D modeling, augmented reality, vehicle safety, autonomous systems, and robotics, where understanding the spatial relationship between objects is a factor. For example, for autonomous or semi-autonomous vehicles or robots, depth information may be used to assist an ego machine in detecting hazards (e.g., foreign material, roadway defects, other vehicles, wild or free-range animals, and/or pedestrians) within its path of travel. In other instances, depth information may be used within a vehicle interior by an occupant monitoring system (OMS). For example, an OMS—using data generated or obtained by sensors of the vehicle or machine—may be used to track the direction of a driver's eye gaze, head pose, or blinking (for example, to detect drowsiness, fatigue, and/or distraction), for hand position and/or gesture detection, child and/or pet presence detection, and/or in conjunction with the operation of features such as, but not limited to, seat belt reminders, seat heating, and/or smart airbag deployment. In other applications, depth images may be used in machine learning applications, such as in conjunction with machine learning models trained to predict 3D information from images captured by cameras, and for verifying the accuracy of such models.

### SUMMARY

Embodiments of the present disclosure relate to depth image analysis and correction for stereo image machine learning systems and applications. Systems and methods are disclosed for evaluating and correcting machine learning model depth images generated from stereo image pairs that may be used in computer vision and perception-based systems.

In contrast to conventional systems, embodiments of the depth image analysis and correction systems and methods described herein may generate ground truth depth images based on depth images generated by a stereo depth perception model from a pair of stereo images of a scene. As described herein, in some embodiments, a process comprises a depth image anomaly identification stage, which may be followed by a depth image correction stage. In some embodiments, a stereo image pair (e.g., left and right stereo images captured by a camera pair with at least partially overlapping fields of view, and/or left and right stereo images captured at offset locations and/or time stamps by a single monocular camera) is fed as input to a stereo depth perception model which then outputs a prediction of a depth image (e.g., a disparity map)—accounting for ego-motion between frames in temporal offset depth image embodiments. Each pixel of the depth image has a value that represents information about a depth measurement from the stereo image pair to a surface in the scene represented by the pixel. A depth image anomaly identification stage of a depth image anomaly processor may perform functions for evaluating a depth image to identify regions (e.g., surfaces of segments) where the values of pixels (predicted by a stereo depth perception model) appear anomalous with respect to accuracy in comparison with other regions of the depth image. For example, in a visual rendering of a depth image (e.g., where pixel depth values are translated to pixel color values) an object sitting on a surface may visually appear normal but contain numerous anomalies with respect to self-consistencies and/or contextual consistencies when the colors are understood as representing depth data.

A depth image anomaly identification stage of a depth image anomaly processor may use image segmentation techniques, such as using one or more image segmentation machine learning models. Image segmentation is a computer vision technique (e.g., that may be performed using image segmentation models and/or other deep learning models) used in object detection tasks that partitions regions of pixels of an image corresponding to distinct features into distinct image segments. The depth image anomaly identification stage may then apply one or more feature classification models to distinct image segments to infer one or more image space classifications for each segment that may indicate whether a segment comprises features that are known to contribute to depth image anomalies. Segments containing potentially anomalous depth values may be evaluated against the image space classification(s) and/or depth values of one or more neighboring (non-suspect) segments. For example, if a surface in a potentially anomalous segment is classified as being a feature physically attached to and/or touching one or more surfaces of neighboring segments, and there is a substantial discontinuity in depth values at pixels where those surfaces interface, then the potentially anomalous segment of the depth image may be relabeled as an identified anomalous segment. In some embodiments, an image segmentation model may aid in identifying those segments having potentially anomalous depth values. The identification of anomalous segments in a predicted depth image may be aided by indications of depth value inconsistencies provided by human inputs to a human-machine interface (HMI) to the anomaly detection system. The identification of regions (e.g., segments) of anomalous depth values may be used to compute an accuracy score or rating for judging the quality of the stereo depth perception model or to otherwise quantify the quality of the depth image output for use, for example, as ground truth for training machine learning models and/or other purposes.

In some embodiments, the process may proceed from the identification stage to a correction stage that adjusts the depth image based on the identified anomalous segments. The anomaly detection system may apply one or more correction techniques that may compute estimates or predictions for depth values within identified anomalous segments, for example, based on contexts provided by depth values of non-anomalous segments, based on detected structural characteristics within the volume of space corresponding to the identified anomalous segments, and/or based on characteristics of local phenomena (e.g., lighting, reflections, glare, etc.) identified as potentially causing the inaccuracies in depth values. In some embodiments, surface fitting of depth values to correct anomalies may be subject to one or more structural constraints based on the geometry of the overall scene as depicted in the stereo image pair. The correction stage of the anomaly detection system may output a corrected depth image wherein the anomalous depth values of one or more identified anomalous segments are corrected using adjusted depth values computed based on interpolation and/or fitting algorithms as described herein. The corrected depth image may then be included with the stereo image pair as a training data sample (e.g., for training and/or evaluating a machine learning model). The corrected depth image may establish a ground truth depth image that may be used to assess an accuracy of a predicted depth image generated by a (e.g. machine learned) stereo depth perception model.

### BRIEF DESCRIPTION OF THE DRAWINGS

The present systems and methods for depth image analysis and correction for stereo image machine learning are described in detail below with reference to the attached drawing figures, wherein:

FIG. 1 is an example data flow diagram of a process for stereo image-based depth value anomaly detection, in accordance with some embodiments of the present disclosure;

FIG. 2A is a data flow diagram illustrating a depth image anomaly identification stage for a depth image anomaly processor, in accordance with some embodiments of the present disclosure;

FIG. 2B is a data flow diagram illustrating an example implementation of a depth image anomaly correction stage for a depth image anomaly processor, in accordance with some embodiments of the present disclosure;

FIGS. 3A-3C illustrate an example process for depth image anomaly correction, in accordance with some embodiments of the present disclosure;

FIG. 4 is a diagram illustrating examples of model constrained surface fitting, in accordance with some embodiments of the present disclosure;

FIG. 5 illustrates an example training process for training a stereo depth perception model, in accordance with some embodiments of the present disclosure;

FIGS. 6A-6B are diagrams illustrating an example process for evaluating the accuracy of one or more stereo depth perception models using one or more depth image anomaly processors, in accordance with some embodiments of the present disclosure;

FIG. 7 is a flow diagram illustrating an example method 700 for depth image anomaly processing, in accordance with some embodiments of the present disclosure;

FIG. 8 is a flow diagram illustrating an example method 800 for generating a depth image from a stereo image pair, in accordance with some embodiments of the present disclosure;

FIG. 9A is an illustration of an example autonomous vehicle, in accordance with some embodiments of the present disclosure;

FIG. 9B is an example of camera locations and fields of view for the example autonomous vehicle of FIG. 9A, in accordance with some embodiments of the present disclosure;

FIG. 9C is a block diagram of an example system architecture for the example autonomous vehicle of FIG. 9A, in accordance with some embodiments of the present disclosure;

FIG. 9D is a system diagram for communication between cloud-based server(s) and the example autonomous vehicle of FIG. 9A, in accordance with some embodiments of the present disclosure;

FIG. 10 is a block diagram of an example computing device suitable for use in implementing some embodiments of the present disclosure; and

FIG. 11 is a block diagram of an example data center suitable for use in implementing some embodiments of the present disclosure.

### DETAILED DESCRIPTION

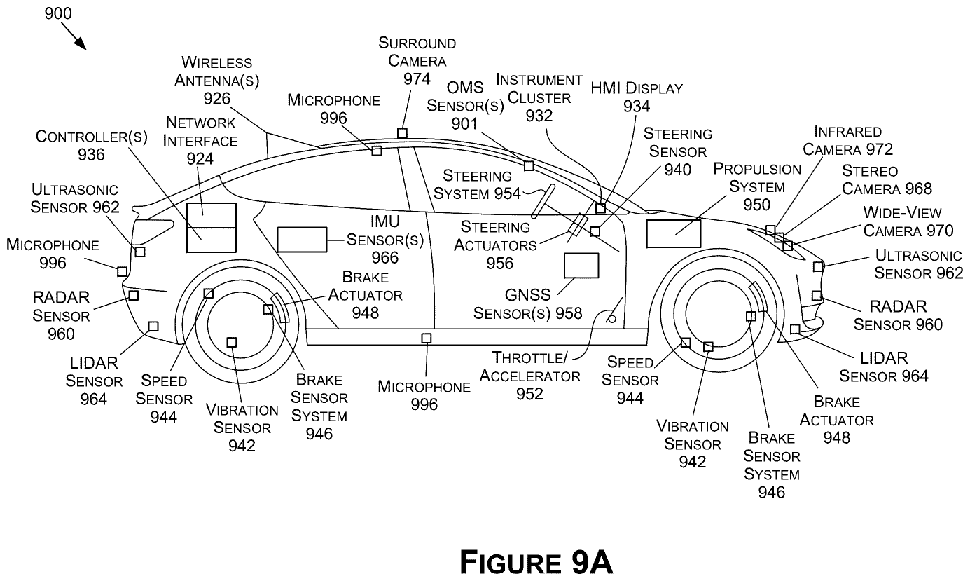

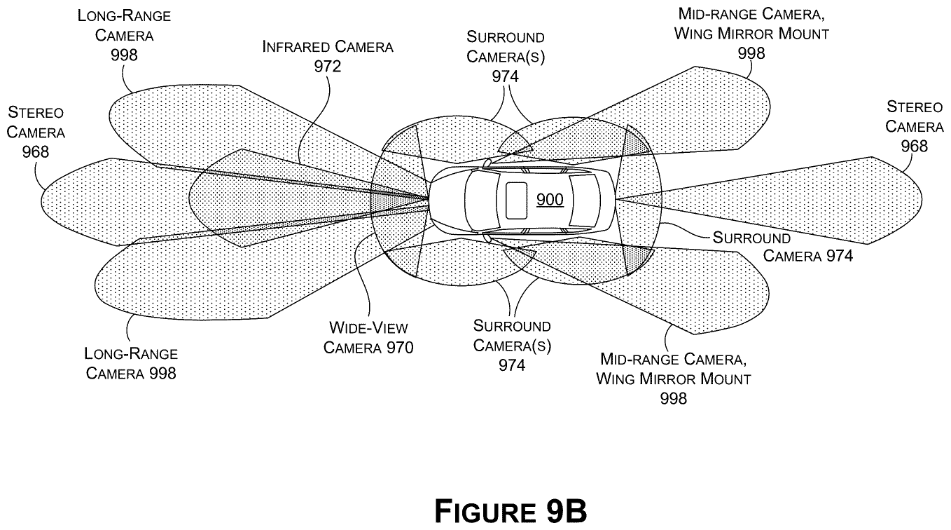

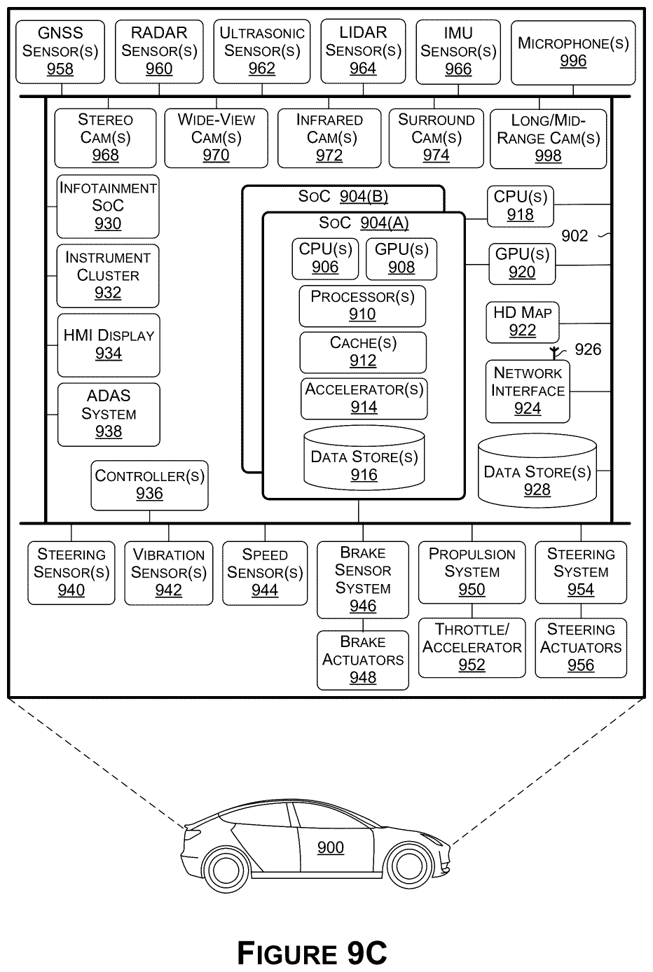

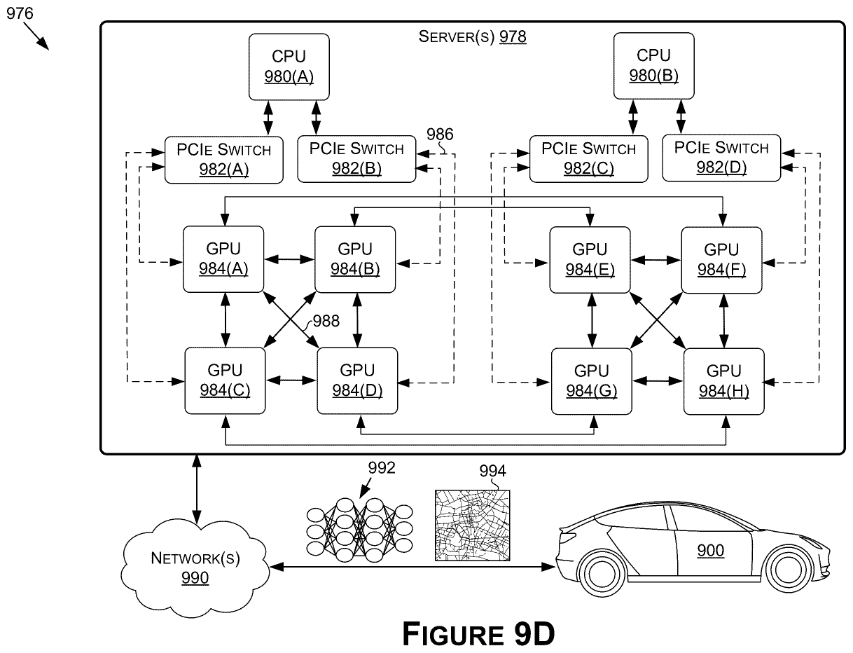

Systems and methods are disclosed related to depth image analysis and correction for stereo image machine learning systems and applications. Although the present disclosure may be described with respect to an example autonomous or semi-autonomous vehicle or machine 900 (alternatively referred to herein as “vehicle 900” or “ego machine 900,” an example of which is described with respect to FIGS. 9A-9D), this is not intended to be limiting. For example, the systems and methods described herein may be used by, without limitation, non-autonomous vehicles or machines, semi-autonomous vehicles or machines (e.g., in one or more advanced driver assistance systems (ADAS)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, trains, underwater craft, remotely operated vehicles such as drones, and/or other vehicle types. In addition, although the present disclosure may be described with respect to stereo vision-based depth perception for autonomous driving, this is not intended to be limiting, and the systems and methods described herein may be used in augmented reality, virtual reality, mixed reality, robotics, security and surveillance, autonomous or semi-autonomous machine applications, and/or any other technology spaces where stereo vision-based depth perception may be used.

The present disclosure relates to stereo image-based computer vision technologies. More specifically, the systems and methods presented in this disclosure provide for technologies for evaluating and correcting machine learning model depth images generated from stereo image pairs that may be used in computer vision-and perception-based systems.

Camera-based technologies for generating depth images are typically less expensive than 3D LiDAR-based technologies, and while they typically give less precise geometry information than 3D LiDAR, cameras provide a large amount of semantically relevant data that can be used, for example, to improve navigation and provide for feature classification. Vision-based perception using camera-captured images presents a significant challenge, however, in part due to the complexity of the algorithms involved, and in part due to the compute required to run them.

Stereo disparity, or binocular disparity, is a geometric term used in the field of computer vision that refers to the difference in image pixel location of an object as seen in left and right stereo images captured by a camera pair. The numeric value of a computed disparity reflects object depth away from the cameras, wherein the bigger the disparity, the closer the object. For example, a pair of image sensors O, O′, may be set up on an ego machine with their respective optical axes aligned in parallel to capture a forward-facing stereo image pair of the path of the ego machine. An object point X observed by the pair of sensors will have a pixel location at (x, y) in the image captured by O, and pixel location (x′, y′) in the image captured by O′. The images can be rectified to where the image rows are aligned such that y=y′. The disparity, d, for a pixel is then defined by the pixel location difference: d=x−x′. Moreover, according to the similar triangle principle, the disparity is proportional to sensor focal length, f, and the baseline length, b, between the two sensors, and is inversely proportional to the object depth, Z, which can be expressed as: d=b*f/Z. As such, a disparity map for the image pair can be constructed in which each element (e.g., each pixel) of the disparity map represents a disparity for a corresponding element of the image captured by O. The resulting image space disparity map may be of the same size in terms of rows and columns as the captured images represent a depth image of a scene as captured by a pair of image sensors.

State-of-the-art (SotA) deep learning-based machine learning models for stereo-based depth estimation (stereo depth perception models) represent an emerging computer vision technology that avoids much of the computational complexities of computing image space disparity maps by training a deep learning model to predict a depth reconstruction for a scene from a pair of stereo images. That said, training such models requires large sets of training data, and collecting and curating a collection of depth image ground truths for an adequate set of training data is a difficult task.

Several ways to create accurate depth image ground truth for training set data samples include LiDAR, structured and unstructured light techniques, and multi-view scene reconstruction techniques.

LiDAR uses light beams to produce point cloud data and is able to obtain long-range depth measurements. However, depth images produced from LiDAR measurements may suffer from small fill factors, errors related to parallax and timing differences, errors related to motion (ego and dynamic objects), and pixel-level alignment accuracy. Structured light techniques generate depth data based on projecting a known pattern of light (e.g., a grid) into a scene. However, this technique typically only works for short-range measurements and indoor environments with controlled lighting and is susceptible to errors caused by real-world effects such as very dark objects or shiny surfaces. This technique also typically has a long acquisition time, and therefore cannot capture moving scenes. Unstructured light techniques project arbitrary projection patterns into the scene and then rely on another calculation technique (such as triangulation) to determine depth. Unstructured light techniques also typically only work for short-range and/or indoor measurements and have resolutions limited by the projected pattern resolution. Structured and unstructured light techniques can both be susceptible to errors caused by real world effects such as very dark objects or shiny surfaces. Multi-view 3D scene reconstruction, such as using Neural Radiance Fields (NeRF), 3D Gaussian splatting, and/or other techniques for rendering 3D volumes from 2D images, is typically limited to static scenes and can be inconsistent with respect to accuracy and resolution. Moreover, an intrinsic part of the problem is not just the accuracy that these different technologies provide, but also the scale at which you can collect ground truth depth images with them. For instance, if the data acquisition using one of these prior techniques takes a long period of time, even if it is very accurate, it remains challenging to scale enough to collect a sufficient corpus of ground truth data samples for training a stereo depth perception model.

In contrast to these prior techniques for generating depth images for ground truth training samples, embodiments of the depth image analysis and correction systems and methods described herein may generate ground truth depth images based on depth images generated by a stereo depth perception model from a pair of stereo images of a scene. As described herein, in some embodiments a process comprises a depth image anomaly identification stage, which may be followed by a depth image correction stage. Moreover, in some embodiments, the techniques described herein may be used for objectively evaluating (e.g., scoring) the accuracy of depth images produced by different stereo depth perception models so that the quality of different stereo depth perception models may be compared.

In some embodiments, a stereo image pair (e.g., left and right stereo images captured by a camera pair, and/or left and right stereo images captured at offset locations by a single monocular camera) is fed as input to a stereo depth perception model, which then outputs a prediction of a depth image (e.g., a disparity map). Each pixel of the depth image has a value that represents information about a depth measurement from the stereo image pair to a surface in the scene represented by the pixel. The resulting depth image may be of the same size in terms of resolution, and/or row and column coordinates, as the captured images of the stereo image pair so that 3D depth information about a feature appearing at a given pixel in the stereo image pair can be determined based on the value of the corresponding pixel of the predicted depth image.

In some embodiments, a depth image anomaly identification stage of a depth image anomaly processor may perform functions for evaluating a depth image to identify regions (e.g., surfaces of a segment) where the values of pixels (predicted by a stereo depth perception model) appear anomalous with respect to accuracy in comparison with other regions of the depth image. For example, in a visual rendering of a depth image (e.g., where pixel depth values are translated to pixel color values), an object sitting on a surface may visually appear normal but contain numerous anomalies with respect to self-consistencies and/or contextual consistencies when the colors are understood as representing depth data. That is, in a depth image, pixel values of a base of an object placed on a surface should have the approximately same values as the adjacent pixel values of the area of the surface upon which the base of the object is touching (e.g., because they are both approximately equidistant from the stereo image sensors used to generate the depth image). Anomalies may appear as occurrences of depth value rate of change discontinuities along a surface of what is otherwise readily discernable from a stereo image pair as being a smooth continuous surface. Other anomalies may appear as inconsistencies and/or discontinuities in depth values along junctions between connected and/or parallel surfaces (e.g., discontinuities in depth values of regions proximate to where a ceiling (or floor) and a wall meet). In many cases, pixels corresponding to a smooth surface that is extending towards a focal point (e.g., a horizon) and relatively uniform in appearance in an image space may provide little disparity between the image pairs for a stereo depth perception model to work with. Such surfaces may thus appear in a depth image prediction as a relatively uniform field of pixel values as opposed to a gradient of pixel values that vary in the direction of the focal point. In some instances, surface characteristics, reflections of images from surfaces, and/or lighting features present in the image space (e.g., the real-work scene represented by optical image data) of a stereo image pair are factors known to cause depth prediction errors in stereo depth perception model-generated depth images. As an example of another type of accuracy anomaly, depth values associated with a feature may not actually be consistent with themselves, such as substantial discontinuities in depth between a base, side, and top of an object that would imply that those regions of the object are not connected and/or immediately adjacent to each other.

As such, an understanding of the physical structure of a scene captured by the stereo image pair may be informative to the task of assessing an accuracy of a depth image produced from the stereo image pair. Based on understanding the types of features (e.g., objects, surfaces, geometries, structures, etc.) that are present in a scene as captured by a stereo image pair, features and factors that are known to contribute to depth image anomalies can be identified and segmented from other regions, so that pixel values in depth images corresponding to those features can be more efficiently assessed.

For example, a depth image anomaly identification stage of a depth image anomaly processor may use image segmentation techniques, such as using one or more image segmentation machine learning models. Image segmentation is a computer vision technique (e.g., that may be performed using image segmentation models and/or other deep learning models) used in object detection tasks that partitions regions of pixels of an image corresponding to distinct features into distinct image segments. The depth image anomaly identification stage may then apply one or more feature classification models to distinct image segments to infer one or more image space classifications for each segment that may indicate whether a segment comprises features that are known to contribute to depth image anomalies. For example, a feature may be classified with a lighting-based artifact image space clarification such as an optical reflection or a lighting source, or as a feature associated with curved or planar surfaces (e.g., a floor, wall, ceiling, staircase, corner, hallway, etc.) that are extending back towards a focal point in an image space, and the depth image anomaly identification stage then locate (and/or label) the corresponding segment of pixels in the depth image for further assessment with respect to the accuracy of their depth values.

In some embodiments, segments containing potentially anomalous depth values may be evaluated against the image space classification(s) and/or depth values of one or more neighboring (non-suspect) segments. For example, if a surface in a potentially anomalous segment is classified as being a feature physically attached to and/or touching one or more surfaces of neighboring segments, and there is a substantial discontinuity in depth values at pixels where those surfaces interface, then the potentially anomalous segment of the depth image may be relabeled as an identified anomalous segment.

In some embodiments, an image segmentation model may aid in identifying those segments having potentially anomalous depth values. For a depth image in a 3D scene, there should generally be a gradient in pixel depth values where depth values gradually increase in the direction of an optical focal point. For example, for a ceiling or floor extending in a direction away from the camera, the depth image should indicate a gradual increase in depth. As such, where a segment lacks such an expected gradient in depth values and can be associated with a segment of the optical image where a gradient should exist, then such a segment of the depth image may be labeled as an identified anomalous segment. In some embodiments, the identification of anomalous segments in a predicted depth image may be aided by indications of depth value inconsistencies provided by human inputs to a human-machine interface (HMI) to the anomaly detection system. For example, the anomaly detection system may display on the HMI one or both images of a stereo image pair and a visual rendering of the depth image predicted by the stereo depth perception model. In some embodiments, segmentation images from the stereo image pair and a visual rendering of the depth image may be displayed. In some embodiments, conversion of the depth image into a point cloud may be displayed, as certain features are easier to detect in 3D as opposed to 2D. A user reviewing the images on the HMI may select one or more regions of pixels that they perceive as potentially anomalous, and that indication of one or more regions may be incorporated as an input into the anomaly detection system for evaluating and/or defining identified anomaly segments. As illustrated by these non-limiting examples, segments comprising depth values that do not exhibit value patterns consistent with the image space classification of that segment, and/or when evaluated in the context of neighboring features, may be identified (and labeled) as having inconsistencies caused by inaccuracies in the stereo depth perception model's depth predictions.

For some use cases directed at machine learning model development, the identification of regions (e.g., segments) of anomalous depth values may be used to compute an accuracy score or rating for judging the quality of the stereo depth perception model or for otherwise quantifying the quality of the depth image output for use, for example, as ground truth for training machine learning models and/or other purposes. For example, pervasiveness and/or severity of anomalous depth values in a depth image produced by a model may be quantified (e.g., by a depth image quality algorithm) into an objective accuracy score. Identified anomaly segment-based accuracy scores may be iteratively computed between stereo depth perception model training session stages to determine if continued training is improving the accuracy of predictions made by the stereo depth perception model. In some embodiments, a set of different stereo depth perception models under evaluation may be fed a set of stereo image pair evaluation samples and the depth image output from each model compared with respect to identified anomalous segments and/or anomaly segment-based accuracy scores to rank the respective accuracy of the models.

In some embodiments, the process may proceed from the identification stage to a correction stage that adjusts the depth image based on the identified anomalous segments. The anomaly detection system may apply one or more correction techniques that may compute estimates or predictions for depth values within identified anomalous segments, for example, based on contexts provided by depth values of non-anomalous segments, based on detected structural characteristics within the volume of space corresponding to the identified anomalous segments, and/or based on characteristics of local phenomena (e.g., lighting, reflections, glare, etc.) identified as potentially causing the inaccuracies in depth values.

In some embodiments, for some use cases directed at inference applications, the identification of regions (e.g., segments) of anomalous depth values in the depth image output from a stereo depth perception model may be used to mask-off the identified anomalous segment so that inaccurate depth value data is not provided to downstream processes (e.g., where a lack of depth data may be less detrimental to the downstream process that is receiving bad depth data).

As another example, an identified anomalous segment of the depth image may be found to be associated with an image space segment that includes one or more lighting-based artifacts such as (but not limited to) light cast from lighting sources, shadows, and instances of reflections and/or glare that appear in a stereo image pair. Lighting-based artifacts in the stereo image pair may compromise the validity of surface information for flat surface geometries available to the stereo depth perception models, resulting in inaccuracies in depth predictions (discontinuities, inconsistencies, inaccurate depth values, etc.) in segments affected by the artifacts. As such, in some embodiments, the anomaly detection system may apply infill and/or interpolation functions to adjust inaccurate depth values based on depth values from one or more neighboring non-anomalous segments. For example, a depth value infill algorithm may use a set of depth value key points selected from non-anomalous segments in the proximity of the identified anomalous segment and interpolate those depth values inwards to fill the anomalous segment with interpolated depth values that smoothly blend with the non-anomalous segments. In some embodiments, the selected depth value key points may comprise three or more key points that define a polygon that at least partially overlays the anomalous segment. The interpolation of depth values may then be performed based at least on a multipoint infill of the polygon.

In some embodiments, other corrective functions may leverage structural geometries identified within the volume of space corresponding to identified anomalous segments, and fit interpolated depth values to surfaces to generate the corrected depth values applied to the anomalous segment. In some embodiments, a surface shape classification may be determined for an identified anomalous segment and then a corresponding shape selected for fitting based on the classification. For example, where an identified anomalous segment falls within the bounds of a flat surface (e.g., a floor, ceiling, wall, tabletop, or the like) then the corrected depth values may be computed based on a linear interpolation and/or extrapolation from the selected non-analogous depth value key points. In some embodiments, where an identified anomalous segment corresponds to a curved surface, the interpolation and/or extrapolation of depth values from the selected non-analogous depth value key points may be adjusted to fit a curved surface using, for example, a polynomial-based fitting algorithm.

Corrected depth values based on surface fitting to individual surfaces may provide locally consistent depth values, but in some cases may result in misalignments between features when pixels of a corrected depth image are projected into 3D space. That is, in some instances, when corrections are applied just based on fitting extrapolations to planes, there is a lacking of enforcement of certain constraints—such as enforcing constraints where points of a first surface are actually in contact with a point of a second surface, or constraints on surface positions where one plane intersects with another plane along a line. As such, in some embodiments, the surface fitting of depth values to correct anomalies may be subject to one or more structural constraints based on the geometry of the overall scene, as depicted in the stereo image pair. For example, for a hallway scene, fittings may be constrained based on a generalized architectural model of a hallway comprising five planes—a floor plane, a ceiling plane, a left-wall plane, a right-wall plane and an end-of-hallway back plane. In such an architectural model of a hallway, the surfaces of the left and right walls may be defined as being parallel to each other and as intersecting with the floor and/or ceiling planes, and the floor and/or ceiling planes may be defined as being parallel to each. When interpolated depth values are then fitted to planes/surfaces to compute corrected depth values, the position and/or orientation of those planes they are fitted to are constrained with respect to each other based on the generalized architectural model selected (e.g., a hallway model, in this example).

In other instances, a scene as depicted in a stereo image pair may include an inside corner or an outside corner, for example where two walls and a floor intersect to form three mutually orthogonal surfaces. Again, interpolated depth values are fitted to the walls and/or floor, and the position and/or orientation of those planes they are fitted to are constrained with respect to a generalized architectural model representing that particular geometry. In some embodiments, the generalized architectural model selected for fitting to compute corrected depth values may be selected from a structural model library of available generalized architectural models based at least on an image space classification of the scene depicted by the stereo image pairs. For example, a classification model applied to the stereo image pairs may infer one or more contextual classifications to the scene (e.g., hallway, room, atrium, stairway, theater, auditorium, etc.) and one or more generalized architectural models selected in order to apply the most relevant set of constraints for fitting to compute corrected depth values for one or more identified anomalous segments of the depth image.

In some embodiments, the correction stage of the anomaly detection system may output a corrected depth image wherein the anomalous depth values of one or more identified anomalous segments are corrected using adjusted depth values computed based on interpolation and/or fitting algorithms, as described herein. The corrected depth image may then be included with the stereo image pair as a training data sample (e.g., for training and/or evaluating a machine learning model). The corrected depth image may establish a ground truth depth image that may be used to assess an accuracy of a predicted depth image generated by a stereo depth perception model. For example, in a training process, a loss function may compute a feedback loss for adjusting a stereo depth perception model based on one or more deviations between a predicted depth image generated by the stereo depth perception model and the ground truth depth image. The stereo depth perception model may be iteratively adjusted to drive the feedback loss to a minimum. Alternatively, such a loss function may otherwise be used to compute an accuracy score or rating for judging the quality of the stereo depth perception model and tracking improvements in the model during the course of a development process.

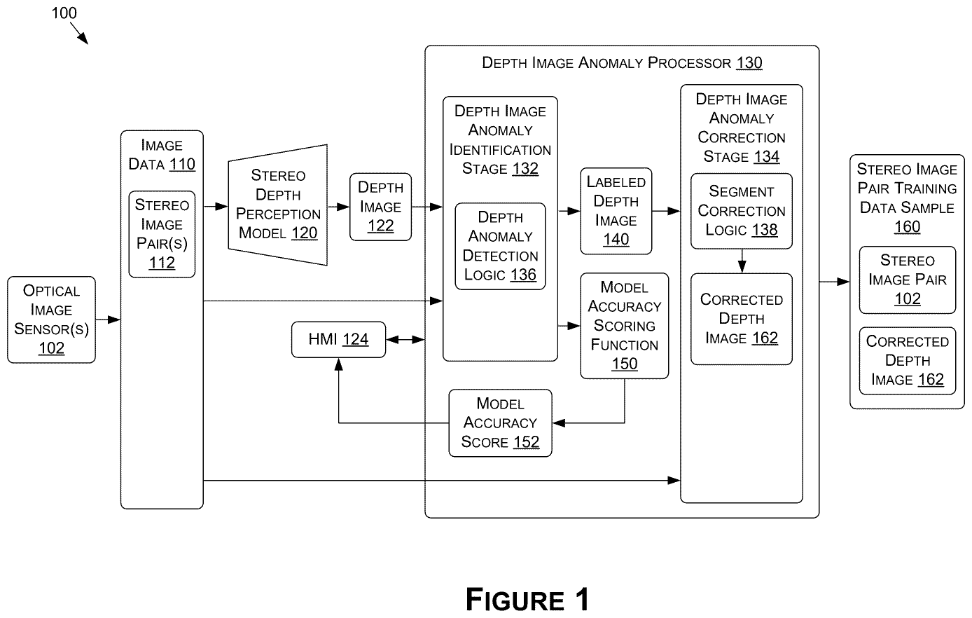

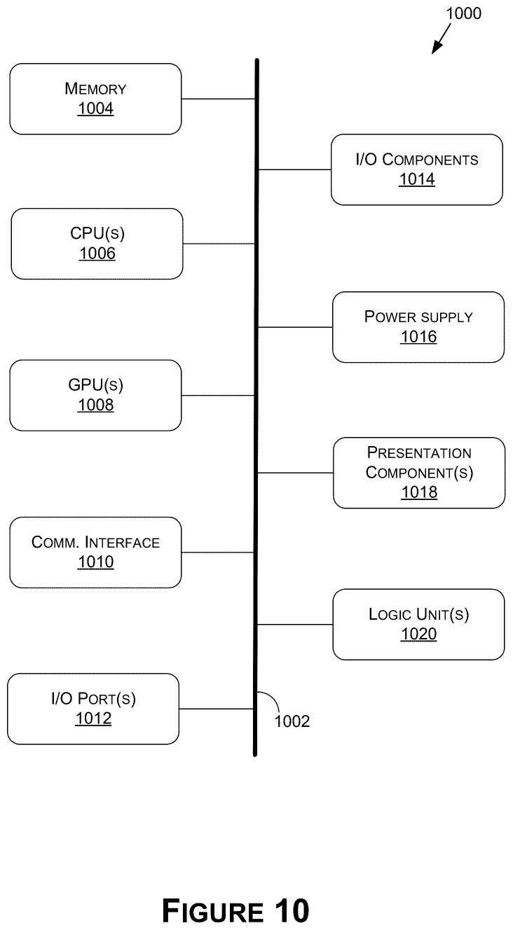

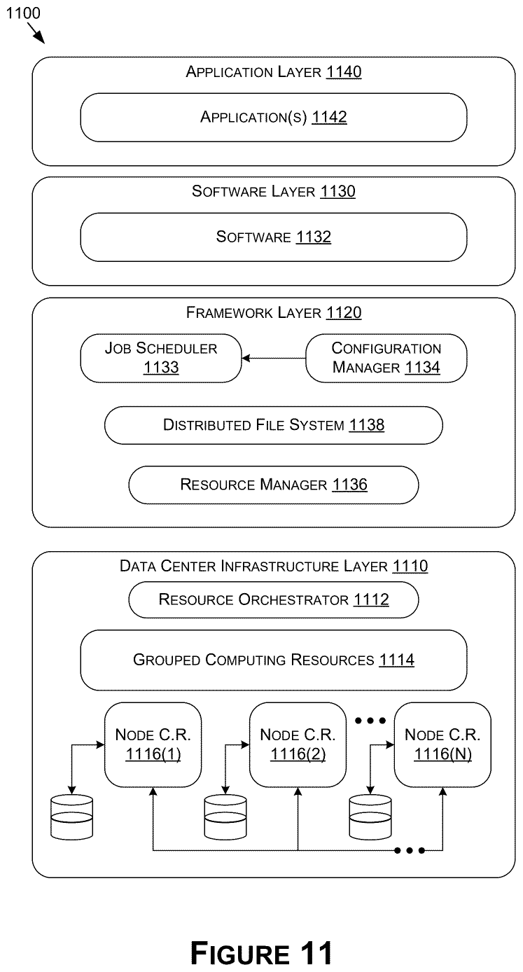

With reference to FIG. 1, FIG. 1 is an example data flow diagram of a process for a stereo anomaly detection system 100, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by one or more processors (e.g., comprising processing circuitry) executing instructions stored in memory. In some embodiments, the systems, methods, and processes described herein may be executed using similar components, features, and/or functionalities to those of example autonomous vehicle 900 of FIGS. 9A-9D, example computing device 1000 of FIG. 10, and/or example data center 1100 of FIG. 11.

As shown in FIG. 1, a stereo anomaly detection system 100 may comprise a depth image anomaly processor 130 that inputs depth image 122 data (produced by a stereo depth perception model 120 from a stereo image pair 112) and can generate a sample of stereo image pair training data 160 comprising a corrected depth image 162. In some embodiments, optical image data 110 comprising stereo image pair(s) 112 may be produced by one or more image sensors 102 (e.g., camera(s)). A stereo image pair 112 may comprise a pair of images simultaneously captured by a set of paired image sensors from offset viewpoints, and/or a pair of images captured by a single image sensor from two offset positions. Image sensor(s) 102 may include, for example, red, green, blue (RGB) cameras, infrared (IR) cameras, RGB-IR cameras, stereo camera arrays, depth cameras, and/or other cameras, such as cameras described with respect to the vehicle 900 of FIGS. 9A-9D. The image sensor(s) 102 may include one or more cameras of an ego object or ego actor, such as stereo camera(s) 968, wide-view camera(s) 970 (e.g., fisheye cameras), infrared camera(s) 972, surround camera(s) 974 (e.g., 360° cameras), occupant monitoring system (OMS) sensor(s) 901, and/or long-range and/or mid-range camera(s) degree 998 of the autonomous vehicle 900 of FIGS. 9A-9D. The image sensor(s) 102 may thus be used to generate the image data 110 of a three-dimensional (3D) environment around an ego object or ego actor.

In some embodiments, depth image anomaly processor 130 may comprise a depth image anomaly identification stage 132. The stereo depth perception model 120 inputs a stereo image pair 112 to produce a prediction comprising the depth image 122. The depth image anomaly identification stage 132 comprises depth anomaly detection logic 136 that evaluates the depth image 122 against the stereo image pair 112 to identify segments of the depth image 122 that are predicted as comprising pixels with inaccurate depth values. The depth image anomaly identification stage 132 may output a labeled depth image 140 that represents a version of the depth image 122, wherein segments identified as having inaccurate depth values are tagged with labels indicating that determination.

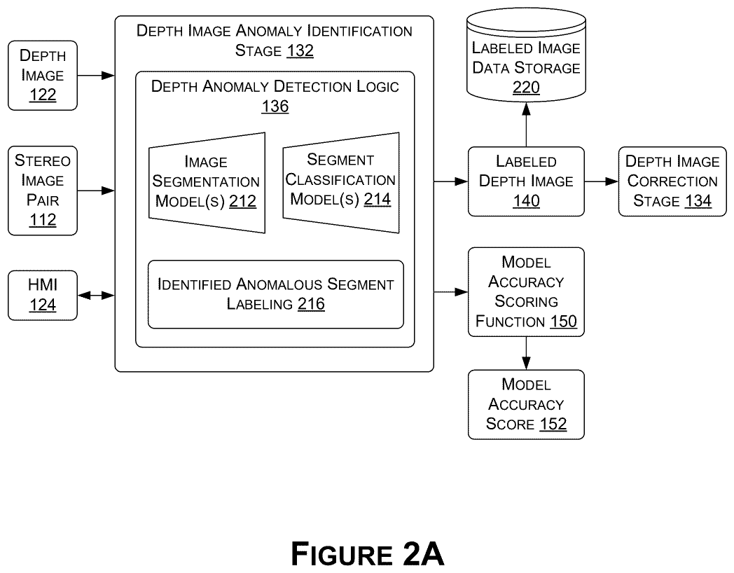

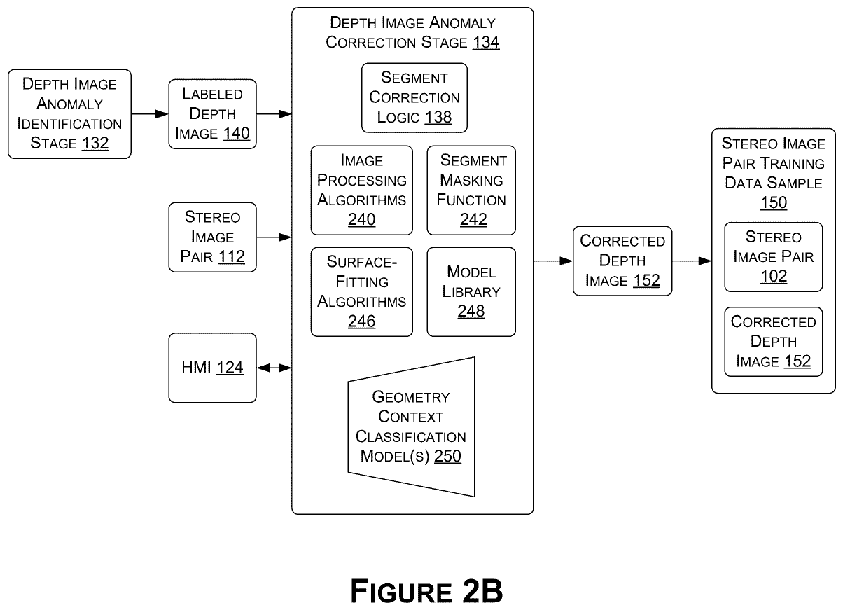

For example, FIG. 2A is a data flow diagram illustrating a depth image anomaly identification stage 132. As shown in this figure, the depth anomaly detection logic 136 may comprise, for example, one or more image segmentation models 212, one or more image segment classification models 214, and/or a segment labeling function 216. In some embodiments, the functions of image segmentation model(s) 212 and image segment classification model(s) 214 may be integrated into a combined machine learning model that generates segmentations and assigns one or more classifications to regions of the depth image 122. The outputs from the image segmentation model(s) 212 and image segment classification model(s) 214 generate data that may characterize the physical structures and/or features of a scene captured by the stereo image pair 112 that aids the depth anomaly detection logic 136 in the task of assessing an accuracy of a depth image produced from the stereo image pair 112. For example, the image segmentation model(s) 212 may segment the stereo image pair 112 into regions of pixels corresponding to distinct physical features (e.g., objects, surfaces, geometries, structures, etc.) present in a scene. The depth anomaly detection logic 136 may correlate segments identified from the stereo image pair 112 with corresponding pixels of a depth image 122 to associate depth data with specific features represented in a segment. In some embodiments, the depth anomaly detection logic 136 itself may comprise and/or be implemented using a machine learning model trained to detect and classify segments of the depth image 122 comprising anomalous (e.g., inaccurate) depth values based on evaluating feature segments extracted from the stereo image pair 112 and depth values of corresponding pixels of the depth image 122. In some embodiments, the image segment classification model(s) 214 may evaluate segments of the depth image 122 generated by the image segmentation model(s) 212 to detect features having characteristics that are known to contribute to depth image anomalies, and to apply a classification (e.g., a tag, label, etc.) to those segments based on the detected characteristics. That is, the image segment classification model(s) 214 may infer one or more classifications for an individual segment that may indicate whether a segment comprises features that are known to contribute to depth image anomalies. For example, the image segment classification model(s) 214 may classify a feature based on an inference that a feature comprises an optical reflection or a lighting source, or as a feature associated with curved or planar surfaces (e.g., a floor, wall, ceiling, staircase, corner, hallway, etc.) that are extending back towards a focal point in an image space. The depth anomaly detection logic 136 may then locate the corresponding segment of pixels in the depth image and more specifically evaluate those segments labeled as comprising features prone to causing anomalous depth data with respect to the accuracy of their depth values based on the classification(s).

For example, in some embodiments, the depth anomaly detection logic 136 may evaluate segments containing potentially anomalous depth values against the classification(s) and/or depth values of one or more neighboring (non-suspect) segments. If a surface in a potentially anomalous segment is classified as being a feature physically attached to and/or touching one or more surfaces of neighboring segments, and the depth anomaly detection logic 136 detects a substantial discontinuity in depth values at pixels where those surfaces interface, then the potentially anomalous segment of the depth image may be relabeled as an identified anomalous segment. In some embodiments, the depth anomaly detection logic 136 may perform functions to identify regions of the depth image 122 (e.g., surfaces of segments) where the values of pixels do not follow an expected pattern of depth values in comparison with other regions of the depth image 122.

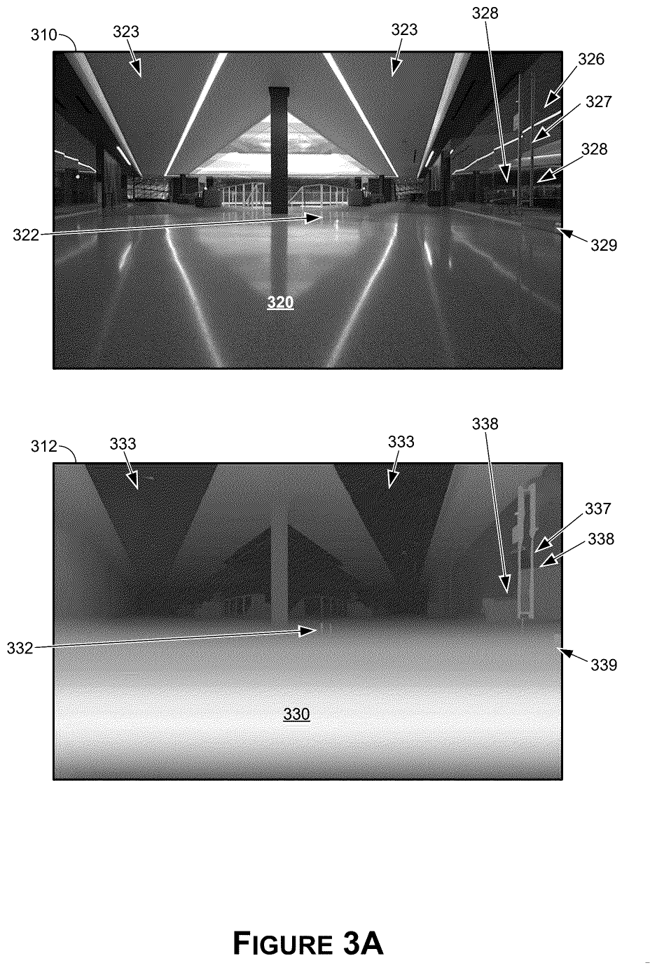

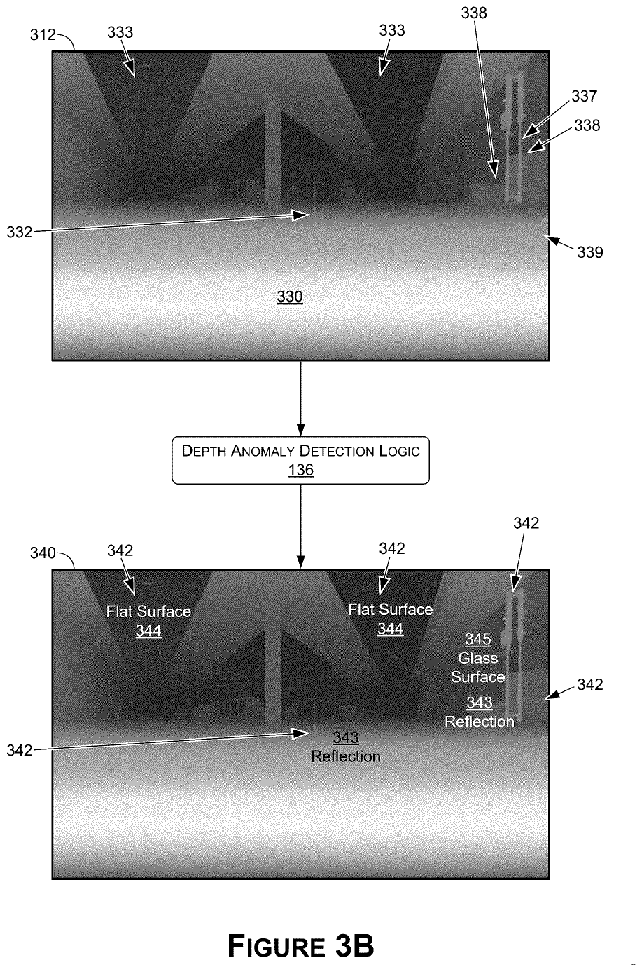

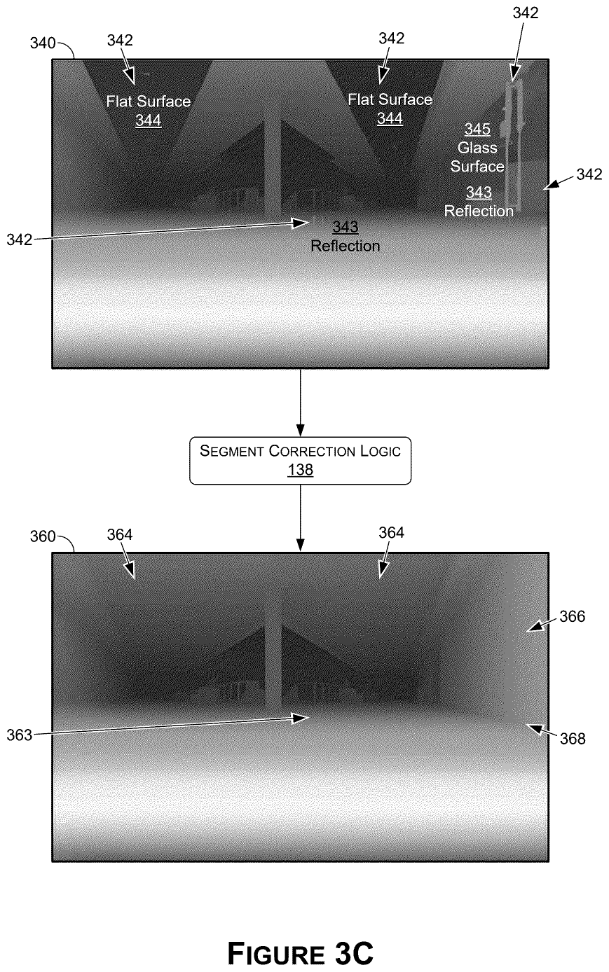

For example, FIG. 3A illustrates an example camera image 310 of a scene (e.g., a scene represented by a stereo image pair 112) and a corresponding example depth image 312 (e.g., a depth image 122 of that same scene, as generated by a stereo depth perception model 120 from the stereo image pair 112). In this example, the region 320 of the camera image 310 represents a floor, and the corresponding region 330 of the depth image 312 comprises a gradation of values with pixels for the floor surface closer to the image sensor having smaller values that gradually increase as the floor surface increases in distance from the sensor—which is an expected (non-anomalous) pattern for a floor. However, anomalies in such surfaces may appear as discontinuities in a depth value pattern across a region of pixels. For example, from the camera image 310, optical reflections are evident on the surface of the floor at 322, which have resulted in a depth value discontinuity and/or inconsistency at 332 of the depth image 312. In this case, the floor segment 320 and reflection segment at 322 may both be classified as being features of the same continuous floor surface, and the substantial discontinuity in the corresponding depth values where those features meet (e.g., more than a threshold) may trigger the depth anomaly detection logic 136 to label the segment 332 of depth values as an identified anomalous segment of depth image 312.

Moreover, the ceiling area 323 depicted in the camera image 310 would be expected to produce a gradation of depth values in the depth image 312 with pixels for the ceiling surface closer to the image sensor having smaller values that gradually increase as the ceiling surface increases in distance from the sensor. However, instead the depth image 312 produced by the stereo depth perception model 120 comprises corresponding regions at 333 that appear as triangular segments where the depth values are relatively homogenous and lacking the expected pattern of a gradation of depth values. In this case, the ceiling area 323 may be classified as a ceiling surface, and the depth anomaly detection logic 136 detects that the corresponding depth values for region 333 of the depth image 312 do not conform to an expected pattern for a ceiling surface, which may trigger the depth anomaly detection logic 136 to label the segment 333 of depth values as an identified anomalous segment. That is, where a segment lacks an expected gradient in depth values and can be associated with a segment of an optical image pair where a gradient should exist, then such a segment of the depth image may be labeled as an identified anomalous segment.

Another set of anomalies may be observed in the region of surface 326 of camera image 310, which represents a series of continuous sections of a glass wall forming a surface extending down the hallway between the floor surface 320 and ceiling 323 surface. In this case, a depth value discontinuity 337 is evident in depth image 312 caused by a door handle 327 present on the other side of the glass wall surface 326, as well as discontinuities 338 caused by optical reflections 328 evident in camera image 310. In each of these cases, the depth values corresponding to the area of the door handle 327 and/or optical reflections 328 do not conform to expected patterns, which may trigger the depth anomaly detection logic 136 to label those segments 337 and 338 of depth values as identified anomalous segments.

As previously mentioned, other anomalies may appear as inconsistencies and/or discontinuities in depth values along junctions between connected and/or parallel surfaces, such as discontinuities where a wall and floor, or a wall and ceiling, physically meet, or other instances with depth values associated with a feature may not be self-consistent, such as substantial discontinuities in depth between a base, side, and top of an object that would imply that those regions of the object are not connected and/or immediately adjacent to each other. In the example of FIG. 3A, the bottom of the glass wall surface 326 is physically attached to the floor surface 320 so that points along the intersection of those surfaces (shown at 329) should be in agreement with respect to their depth values in depth image 312. That is, the gradient pattern of depth values along the glass wall surface 326 should track the gradient pattern of depth values along the floor surface 320. However, as shown in depth image 312, the corresponding depth values at segment 339 lack the expected correspondence in depth values. As such, the depth values corresponding to the intersection of those surfaces do not conform to expected patterns, which may trigger the depth anomaly detection logic 136 to label those segments of depth values as an identified anomalous segment.

In some embodiments, the depth anomaly detection logic 136 may be aided in identifying anomalous segments in a predicted depth image 122 based on inconsistency indications provided as inputs by a human user to a human-machine interface (HMI) 124. For example, the anomaly detection system may display on the HMI 124 one or both images of a stereo image pair 112 and a visual rendering of the depth image 122 predicted by the stereo depth perception model 120. In some embodiments, conversion of the depth image into a point cloud may be displayed, as certain features are easier to detect in 3D as opposed to 2D. A user reviewing the images on the HMI 124 may select one or more regions of pixels that they perceive as potentially anomalous, and that indication of one or more regions may be incorporated as an input into the depth anomaly detection logic 136 used for defining identified anomaly segments.

As illustrated by these non-limiting examples, segments comprising depth values that do not exhibit value patterns consistent with the classification of that segment in an image space, and/or when evaluated in the context of neighboring features, may be identified (and labeled) by the depth image anomaly identification stage 132 as having inconsistencies caused by inaccuracies in the stereo depth perception model's depth predictions.

Based at least on one or more identified anomaly segments identified by the depth anomaly detection logic 136, the segment labeling function 216 may generate a labeled depth image 140 comprising an updated version of the depth image 122 that includes labels that tag the one or more identified anomaly segments as identified anomaly segments, such as illustrated by the example labeled depth image 340 in FIG. 3B. As shown in FIG. 3B, the segment labeling function 216 may update the initial depth image 312 to produce the labeled depth image 340 that includes one or more segments labeled as comprising identified anomalous segments (shown at 342). In some embodiments, the segment labeling function 216 may further label segments to include metadata based on the classifications inferred by the segment classification model(s) 214. For example, identified anomalous segments 342 may be further labeled to indicate that they comprise optical reflections (343), large flat surfaces (344), or glass or otherwise transparent features (345), and/or may be labeled with other metadata that may assist in characterizing the nature of the feature and/or cause of inaccurate depth value predictions for that feature. As discussed below, in some embodiments such labeling and/or metadata may be used to perform depth image anomaly correction. Labeled depth image(s) 140 produced by the depth image anomaly identification stage 132 may be stored to a labeled image data storage 220 (e.g., a database, data store, etc.) so that they may be retrieved for subsequent analysis, used as data samples for training machine learning models, and/or other purposes.

In some embodiments, labeled depth image(s) 140 may be used to compute an accuracy score or rating for judging the quality of the stereo depth perception model or to otherwise quantify the quality of the depth image output for use, for example, as ground truth for training machine learning models and/or other purposes. For example, the depth image anomaly processor 130 may comprise a model accuracy scoring function 150 that inputs the labeled depth image(s) 140 and/or other data produced by the depth image anomaly identification stage 132, and outputs a model accuracy score 152 that may be presented via the HMI 124. For example, pervasiveness and/or severity of anomalous depth values in a depth image produced by a model may be quantified (e.g., by a depth image quality algorithm) into an objective accuracy score. Identified anomaly segment-based accuracy scores may be iteratively computed between stereo depth perception model training session stages to determine if continued training is improving the accuracy of predictions made by the stereo depth perception model.

Returning to FIG. 1, in some embodiments, the labeled depth image(s) 140 may be applied to a depth image anomaly correction stage 134 that produces a corrected depth image 162 by applying adjustments to the depth image 122 based on the identified anomalous segments 342. The depth image anomaly correction stage 134 may include segment correction logic 138 that applies one or more correction techniques to one or more of the identified anomalous segments 342 to at least partially mitigate inaccuracies in depth values in those segments. For example, the segment correction logic 138 may comprise algorithms that compute estimates or predictions of what the depth values should be within those identified anomalous segments. For example, segment correction logic 138 may compute corrected depth values based on the context associated with an identified anomalous segment (e.g., based on depth values of adjacent non-anomalous segments, based on detected structural characteristics within the volume of space corresponding to an identified anomalous segments, and/or based on characteristics of local phenomena (e.g., lighting, reflections, glare, etc.) identified as potentially causing the inaccuracies in depth values). In some embodiments, the depth image anomaly correction stage 134 may output a stereo image pair training data sample 160 that comprises the stereo image pair 112 and a corresponding corrected depth image 162 derived from the stereo image pair 112 by the depth image anomaly processor 130. Such as training data sample 160 may be used for training machine learning models, such as stereo depth perception model 120, where the corrected depth image 162 provides a ground truth sample (e.g., an image representing the depth image that should be predicted by the model based on an input comprising the stereo image pair 112).

FIG. 2B is a data flow diagram illustrating an example implementation of a depth image anomaly correction stage 134. As shown in this figure, the segment correction logic 138 may comprise, for example, one or more image processing algorithms 240, one or more segment masking functions 242, one or more surface-fitting algorithms 246, structure model library 248, and/or one or more geometry context classification models 250.

In some embodiments, the segment correction logic 138 may comprise one or more image processing algorithms 240 that comprise image processing tools and/or filters that apply infill-and/or interpolation-based adjustments to a segment of labeled depth image 140 to correct inaccurate depth values based on depth values from one or more neighboring non-anomalous segments. An identified anomalous segment 342 may be determined (e.g., based on a label and/or metadata) to be associated with an image space segment of the stereo image pair 112 that includes artifacts that produce depth value discontinuities (e.g., lighting-based artifacts such as, but not limited to, lighting sources, shadows, reflections, and/or glare). In some embodiments, the segment correction logic 138 executes image processing algorithms 240 to apply infill and/or interpolation functions to adjust inaccurate depth values. For example, an infill algorithm may select a set of depth value key points from non-anomalous segments in the proximity of an identified anomalous segment and interpolate those depth values inwards to fill the anomalous segment with interpolated depth values that smoothly blend with the non-anomalous segments. In some embodiments, the selected depth value key points may comprise three or more key points that define a polygon that at least partially overlays the anomalous segment. The interpolation of depth values may then be performed by the image processing algorithms 240 based at least on a multipoint infill of the polygon.

In some embodiments, the segment correction logic 138 may apply the segment masking function 242 to one or more identified anomalous segments 342 to mask-off the anomalous segments from appearing with depth values in the corrected depth image 162. Masking-off identified anomalous segments 342 may be performed so that inaccurate depth value data is not provided to downstream processes (e.g., where a lack of depth data may be less detrimental to the downstream process that is receiving bad depth data).

In some embodiments, the segment correction logic 138 may apply other corrective functions that leverage structural geometries associated with identified anomalous segments 342 and fit interpolated depth values to surfaces using one or more surface-fitting algorithms 246 to generate the corrected depth values for corrected depth image 162. In some embodiments, a surface shape classification may be determined from metadata for an identified anomalous segment and then a corresponding shape selected by the surface-fitting algorithm(s) 246 for fitting based on the classification. For example, where an identified anomalous segment falls within the bounds of a surface characterized as a flat surface (e.g., a floor, ceiling, wall, tabletop, or the like) then the corrected depth values may be computed based on a linear interpolation and/or extrapolation from the selected non-analogous depth value key points and fit to the flat surface by the one or more surface-fitting algorithms 246 using a linear surface-fitting algorithm. Where an identified anomalous segment falls within the bounds of a surface characterized as a curved surface, the interpolation and/or extrapolation of depth values from the selected non-analogous depth value key points may be adjusted to fit a curved surface by the one or more surface-fitting algorithms 246 using, for example, a polynomial-based fitting algorithm.

FIG. 3C provides a non-limiting example of where the segment correction logic 138 processes the labeled depth image 340 to produce a corrected depth image 360. The labeled depth image 340 may include one or more segments labeled as comprising identified anomalous segments 342, and the labeled depth image 340 may further label segments 342 to include metadata, for example based on a classification applied to a segment by the depth anomaly detection logic 136. As shown in the corrected depth image 360, the segment correction logic 138 has applied at least one image processing algorithm 240 so the depth values of pixels displaying optical reflections 343 have been infilled or otherwise smoothed in the corrected depth image 360 based on neighboring depth values (shown at 363). The large flat surface segment (344) associated with the ceiling surfaces have been corrected by the image processing algorithm(s) 240 and/or surface-fitting algorithm(s) 246 to apply interpolated values with a flat surface fitting to render as the expected gradient pattern of depth values (shown at 364). Similarly, for the glass wall surface 326, the discontinuity 337 caused by the support pillar 327 and discontinuities 338 caused by optical reflections 328 have been corrected by the image processing algorithm(s) 240 and/or surface-fitting algorithm(s) 246 to apply interpolated values with a flat surface fitting to render as the expected gradient pattern of depth values (shown at 366). Moreover, with respect to the glass wall surface 326, the surface-fitting algorithms 246 may be subject to one or more structural constraints based on the intersection of the glass wall surface with the surface of the floor at 322 to correct discontinuities in depth values where those surfaces intersect, as shown at 368.

As explained above, the surface-fitting algorithm(s) 246 may provide for locally consistent depth values by surface fitting a set of depth values to a specific surface of a feature in a scene (e.g., to a floor, to a table top, etc.). However, in some cases such surface fitting may result in misalignments between distinct but related surfaces in the scene. For example, a first set of depth values may be corrected by surface fitting those values to a surface of a floor, and a second set of depth values may be corrected by separately surface fitting those values to a surface of an adjacent wall. However, when pixels of the resulting corrected depth image are projected into 3D space, inconsistencies may be revealed. An adjacent floor and wall may exhibit inaccurate alignments and/or other inaccurate spatial relationships (such as with respect to accurately representing where the surfaces intersect). In other words, in some instances when applying corrections based on locally fitting extrapolations to distinct planes, there is a lacking in the enforcement of certain structural constraints - such as enforcing constraints where a first surface interfaces with a second surface, or constraints on surface positions where one plane intersects with another plane along a line.

As such, in some embodiments the surface-fitting algorithms 246 may apply one or more structural constraints based on the geometry of the overall scene as depicted in the stereo image pair 112. In some embodiments, interpolated depth values may be fitted to planes/surfaces of an architectural model to compute corrected depth values so that the position and/or orientation of those surfaces are constrained with respect to each other based on the generalized architectural model selected (e.g., a hallway model, in this example).

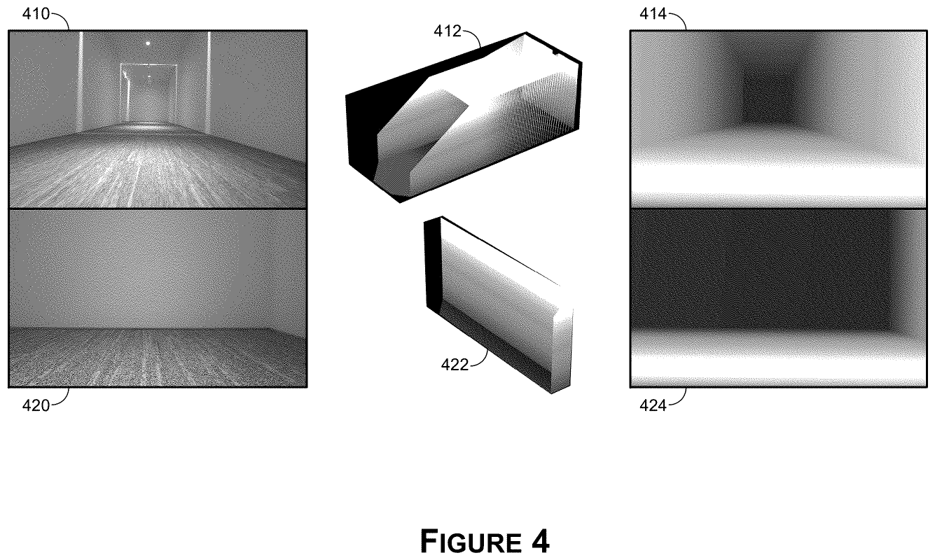

By way of a non-limiting example, FIG. 4, for a hallway scene 410, surface-fitting algorithms 246 may be constrained based on a generalized architectural model, such as an architectural hallway model as shown at 412. The architectural hallway model 412 may comprise five planes (e.g., a floor plane, a ceiling plane, a left-wall plane, a right-wall plane and/or an end-of-hallway back plane) having a predefined structural relationship. For example, for an architectural hallway model 412, the surfaces of opposing left and right walls may be defined as being parallel to each other, and as orthogonally intersecting with the floor and/or ceiling planes, with the floor and/or ceiling planes also defined as being parallel to each other. As shown at 414, interpolated depth values may be fitted to planes/surfaces of architectural hallway model 412 to compute corrected depth values so that the position and/or orientation of those surfaces are constrained with respect to each other—avoiding discontinuities that may arise from more localized surface fittings. As another example, for a scene 420 depicting a corner of a room, the surface-fitting algorithms 246 may be constrained based on another generalized architectural model, such as an architectural room as shown at 422. The architectural room model 422 may comprise three planes (e.g., a floor plane, a left-wall plane, and a right-wall plane) having a predefined structural relationship. For example, for the architectural room model 422, the surfaces of left and right walls may be defined as extending from the floor and forming a right-angled corner. As shown at 424, interpolated depth values may be fitted to planes/surfaces of the architectural room model 422 to compute corrected depth values so that the position and/or orientation of those surfaces are constrained with respect to each other—avoiding discontinuities that may arise from more localized surface fittings.

In some embodiments, the surface-fitting algorithm(s) 246 may select a generalized architectural model for fitting to compute corrected depth values from a model library 248 that comprises a plurality of generalized three-dimensional architectural models depicting various standard geometries that may be used for surface fitting. In some embodiments, the one or more geometry context classification models 250 may input the image data (e.g., stereo image pair 112) and infer an architectural geometry that characterizes at least a portion of the scene (e.g., a hallway, room, atrium, stairway, theater, auditorium, and so forth). Based on the architectural geometry classification, the surface-fitting algorithm(s) 246 may select a corresponding generalized architectural model from the model library 248. Using the selected generalized architectural model, the surface-fitting algorithm 246 may apply the most relevant set of constraints for fitting to compute corrected depth values for one or more identified anomalous segments of the depth image to produce the corrected depth image 162. In some embodiments, more than one architectural model may be selected and applied by the surface-fitting algorithm 246 to fit depth values to produce a corrected depth image 162.

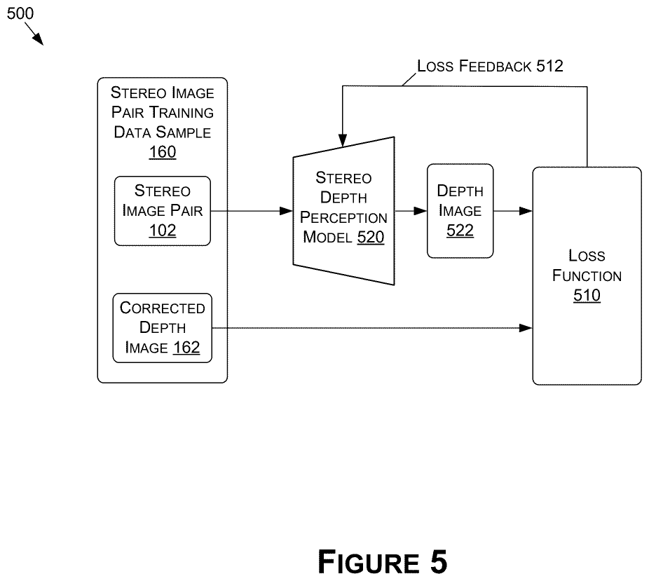

FIG. 5 illustrates an example training process 500 for training a stereo depth perception model 520 (e.g., stereo depth perception model 120). In training process 500, the training data sample 160 comprises stereo image pair 102 and a corresponding corrected depth image 162 derived from the stereo image pair 112 by the depth image anomaly processor 130. The stereo depth perception model 520 under training generates a prediction comprising a depth image 522. The depth image 522 and corrected depth image 162 are input to a loss function 510 that computes a loss feedback 512 that is used to adjust a stereo depth perception model 520 based on one or more deviations between the depth image 522 and the corrected depth image 162. The stereo depth perception model 520 may be iteratively adjusted while applying a series of training data samples 160 to drive the loss feedback 512 towards a minimum loss where the depth image 522 produced by the stereo depth perception model 520 is substantially similar to the corrected depth image 162 ground truth. In some embodiments, a loss function such as loss function 510 may be used by the model accuracy scoring function 150 to compute an accuracy score or rating for judging the quality of the stereo depth perception model (e.g., model accuracy score 152) and/or for tracking improvements in the model during the course of a development process.

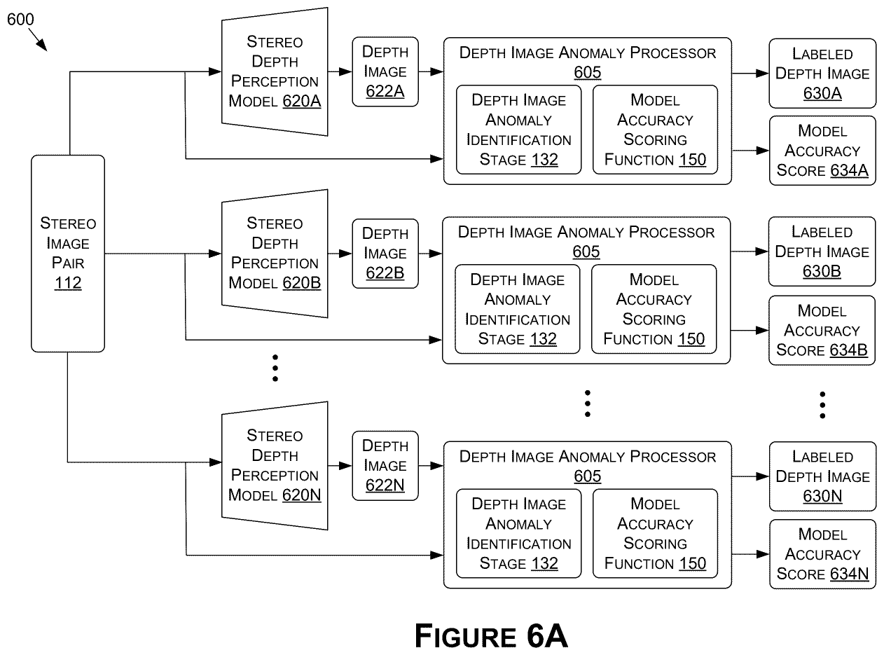

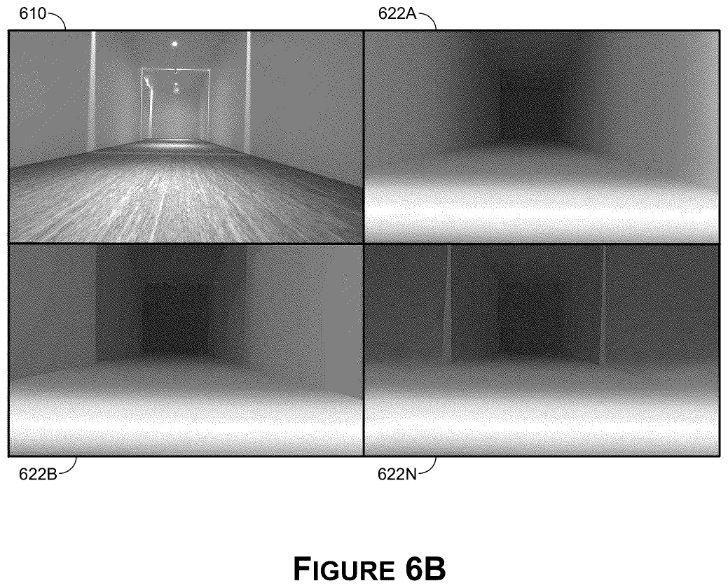

FIG. 6A is a data flow diagram illustrating an example process 600 for evaluating the accuracy of one or more stereo depth perception models using one or more depth image anomaly processor(s) 605. In some embodiments, the depth image anomaly processor(s) 605 may comprise at least a depth image anomaly identification stage 132 such as described with respect to FIGS. 1 and 2A, and may further include a model accuracy scoring function 150 such as described with respect to FIGS. 1 and 2A. As shown in FIG. 6A, the process 600 may be used for evaluating a set comprising any number of different depth perception models (shown as 620a and 620b to 620n) so that the relative accuracy and/or quality of each respective model may be compared against each other. In some embodiments, the depth perception models 620a to 620n may individually comprise a different version or variant of a stereo depth perception model such as the stereo depth perception model 120 described with respect to FIG. 1. That is, each stereo depth perception model 620a to 620n inputs a stereo image pair 112 to produce a respective prediction comprising a depth image (shown as 622a, 622b to 622n). The stereo image pair 112 (e.g., left and right stereo images captured by a camera pair, and/or left and right stereo images captured at offset locations by a single monocular camera) is fed as input to the depth perception models 620a to 620n, which then individually output a prediction of a depth image 622a to 622n (e.g., a disparity map). Each pixel of the depth images 622a to 622n has a value that represents information about a depth measurement from the stereo image pair 112 to a surface in the scene represented by the pixel. Although each of the depth perception models 620a to 620n may input the same stereo image pair 112, they may nonetheless produce differing predictions of depth images 622a to 622n based on differences in their particular machine learning model architecture, differences in the training data and/or loss functions used in their training processes, and/or because of other design factor(s). For example, referring to FIG. 6B, the image 610 is an example image of a hallway scene captured by optical image sensor(s) and input into the stereo depth perception models 620a to 620n as the stereo image pair 112. In this example, stereo depth perception model 620a may comprise a cascaded recurrent network with adaptive correlation (CREStereo)-based stereo matching network that predicts the depth image 622a based on stereo image pair 112; stereo depth perception model 620b may comprise a recurrent all-pairs field transforms (RAFT)-Stereo-based deep architecture that predicts the depth image 622b from stereo image pair 112 based on optical flow; and stereo depth perception model 620n may comprise a unifying flow, stereo and depth estimation-based network (e.g., a GMStereo model) that predicts the depth image 622n from stereo image pair 112.

As shown in FIG. 6A, the depth image anomaly processor(s) 605 may input the stereo image pair 112 and the resulting depth image produced by a stereo depth perception model. Based on these inputs, the depth image anomaly processor(s) 605 may execute the depth image anomaly identification stage 132 to generate a labeled depth image (shown as labeled depth images 630a, 630b to 630n). The depth image anomaly identification stage 132 may output a labeled depth image 630a, 630b to 630n that represents a version of the corresponding depth image 622a, 622b to 622n, wherein segments identified as having inaccurate depth values are tagged with labels indicating that determination. The depth image anomaly processor(s) 605 may execute the model accuracy scoring function 150 that inputs the labeled depth image(s) 630a, 630b to 630n and/or other data produced by the depth image anomaly identification stage 132, and outputs respective model accuracy scores 634a, 634b to 634n. For example, the model accuracy scoring function 150 may evaluate the pervasiveness and/or severity of anomalous depth values (e.g., identified anomalous segments) in the depth images and quantify the pervasiveness and/or severity (e.g., using a depth image quality algorithm) into an objective accuracy score that is output as the respective model accuracy scores 634a, 634b to 634n. In some embodiments, the model accuracy scores may be compared with each other and/or in context with the labeled depth image(s) 630a, 630b to 630n, for example, to rank the quality of the models, select the suitability of a model for use in a particular application, and/or determine if one or more of the models should undergo further training.

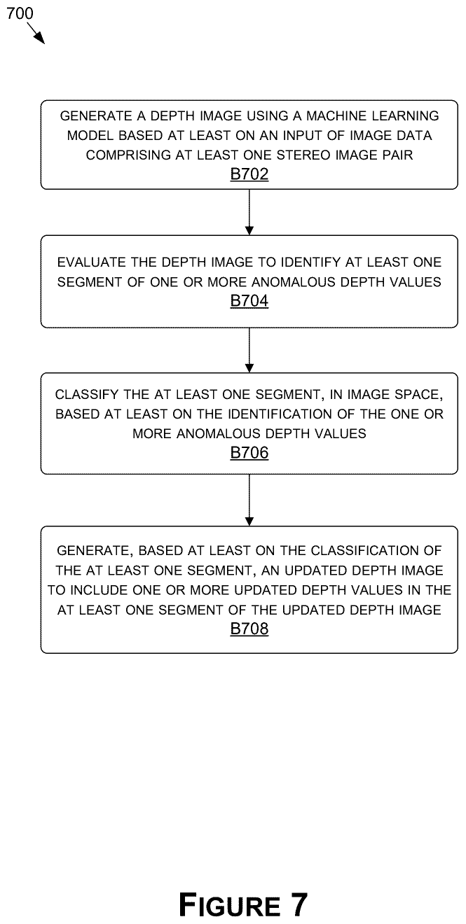

FIG. 7 is a flow diagram illustrating an example method 700 for depth image anomaly processing, in accordance with some embodiments of the present disclosure. It should be understood that the features and elements described herein with respect to the method 700 of FIG. 7 may be used in conjunction with, in combination with, or substituted for elements of any of the other embodiments discussed herein and vice versa. Further, it should be understood that the functions, structures, and other descriptions of elements for embodiments described in FIG. 7 may apply to like or similarly named or described elements across any of the figures and/or embodiments described herein and vice versa.

Each block of method 700, described herein, comprises a computing process that may be performed using any combination of hardware, firmware, and/or software. For instance, various functions may be carried out by one or more processors (comprising processing circuitry) executing instructions stored in memory. The methods may also be embodied as computer-usable instructions stored on computer storage media. The methods may be provided by a standalone application, a service or hosted service (standalone or in combination with another hosted service), or a plug-in to another product, to name a few. In addition, method 700 is described, by way of example, with respect to the stereo anomaly detection system 100 of FIG. 1. However, these methods may additionally or alternatively be executed by any one system, or any combination of systems, including, but not limited to, those described herein.

As discussed herein in greater detail, the method may in general include generating a corrected depth image comprising depth information represented by a stereo image pair based at least on evaluating an initial depth image generated by applying the stereo image pair as input to a machine learning model, the evaluating to identify at least one segment of the first depth image comprising one or more anomalous depth values, wherein the at least one segment is identified based at least on an image space classification of the at least one segment.

The method 700, at block B702, includes generating a depth image using a machine learning model based at least on an input of image data comprising at least one stereo image pair. In some embodiments, a stereo image pair (e.g., left and right stereo images captured by a camera pair, and/or left and right stereo images captured at offset locations by a single monocular camera) may be fed as input to a stereo depth perception model which then outputs a prediction of a depth image (e.g., a disparity map). Each pixel of the depth image has a value that represents information about a depth measurement from the stereo image pair to a surface in the scene represented by the pixel. The resulting depth image may be of the same size in terms of resolution, and/or row and column coordinates, as the captured images of the stereo image pair so that 3D depth information about a feature appearing at a given pixel in the stereo image pair can be determined based on the value of the corresponding pixel of the predicted depth image. As discussed with respect to FIG. 1, a stereo depth perception model 120 may input a stereo image pair 112 to produce a prediction comprising the depth image 122. Optical image data 110 comprising stereo image pair(s) 112 may be produced by one or more image sensors 102 (e.g., camera(s)). A stereo image pair 112 may comprise a pair of images simultaneously captured by a set of paired image sensors from offset viewpoints, and/or a pair of images captured by a single image sensor from two offset positions. Image sensor(s) 102 may include, for example, RGB cameras, IR cameras, RGB-IR cameras, stereo camera arrays, depth cameras, and/or other cameras, such as cameras described with respect to the vehicle 900 of FIGS. 9A-9D. The image sensor(s) 102 may include one or more cameras of an ego object or ego actor, such as stereo camera(s) 968, wide-view camera(s) 970 (e.g., fisheye cameras), infrared camera(s) 972, surround camera(s) 974 (e.g., 360° cameras), occupant monitoring system (OMS) sensor(s) 901, and/or long-range and/or mid-range camera(s) degree 998 of the autonomous vehicle 900 of FIGS. 9A-9D.

The method 700, at block B704, includes evaluating the depth image to identify at least one segment of one or more anomalous depth values. The method may include identifying the at least one segment based at least on a depth value pattern associated with the image space classification of the at least one segment. The method may include identifying the at least one segment based at least on identifying one or more depth value discontinuities within the at least one segment.

The method 700, at block B706, includes classifying the at least one segment, in image space, based at least on the identification of the one or more anomalous depth values. In some embodiments, as described with respect to FIGS. 1 and 2A, a depth image anomaly identification stage 132 may comprise depth anomaly detection logic 136 that evaluates the depth image 122 against the stereo image pair 112 to identify segments of the depth image 122 that are predicted as comprising pixels with inaccurate depth values. The depth anomaly detection logic 136 may comprise, for example, one or more image segmentation models 212, one or more image segment classification models 214, and/or a segment labeling function 216. The outputs from the image segmentation model(s) 212 and image segment classification model(s) 214 generate data that may characterize the physical structures and/or features of a scene captured by the stereo image pair 112 that aids the depth anomaly detection logic 136 in the task of assessing an accuracy of a depth image produced from the stereo image pair 112. For example, the image segmentation model(s) 212 may segment the stereo image pair 112 into regions of pixels corresponding to distinct physical features (e.g., objects, surfaces, geometries, structures, etc.) present in a scene. The depth anomaly detection logic 136 may correlate segments identified from the stereo image pair 112 with corresponding pixels of a depth image 122 to associate depth data with specific features represented in a segment. The image segment classification model(s) 214 may evaluate segments of the depth image 122 generated by the image segmentation model(s) 212 to detect features having characteristics that are known to contribute to depth image anomalies, and apply a classification (e.g., a tag, label, etc.) to those segments based on the detected characteristics. That is, the image segment classification model(s) 214 may infer one or more image space classifications (e.g., a surface geometry classification) for an individual segment that may indicate whether a segment comprises features that are known to contribute to depth image anomalies. For example, the image segment classification model(s) 214 may classify a feature based on an inference that a feature comprises an optical reflection or a lighting source, or as a feature associated with curved or planar surfaces (e.g., a floor, wall, ceiling, staircase, corner, hallway, etc.) that are extending back towards a focal point in an image space. The depth anomaly detection logic 136 may then locate the corresponding segment of pixels in the depth image and more specifically evaluate those segments labeled as comprising features prone to causing anomalous depth data with respect to the accuracy of their depth values based on the classification(s). The depth anomaly detection logic 136 may evaluate segments containing potentially anomalous depth values against the classification(s) and/or depth values of one or more neighboring (non-suspect) segments. Based at least on one or more identified anomaly segments identified by the depth anomaly detection logic 136, the segment labeling function 216 may generate a labeled depth image 140 comprising an updated version of the depth image 122 that includes labels that tag the one or more identified anomaly segments as identified anomaly segments.

In some embodiments, the at least one segment may be identified based at least on an input from a human-machine interface comprising an indication of the at least one segment as comprising the one or more anomalous depth values. That is, the depth anomaly detection logic 136 may be aided in identifying anomalous segments in a predicted depth image 122 based on inconsistency indications provided as inputs by a human user to a human-machine interface (HMI) 124. For example, the anomaly detection system may display on the HMI 124 one or both images of a stereo image pair 112 and a visual rendering of the depth image 122 predicted by the stereo depth perception model 120. In some embodiments, conversion of the depth image into a point cloud may be displayed, as certain features are easier to detect in 3D as opposed to 2D. A user reviewing the images on the HMI 124 may select one or more regions of pixels that they perceive as potentially anomalous, and that indication of one or more regions may be incorporated as an input into the depth anomaly detection logic 136 used for defining identified anomaly segments.

The method 700, at block B708, includes generating based at least on the classification of the at least one segment, an updated depth image to include one or more updated depth values in the at least one segment of the updated depth image. For example, based at least on one or more identified anomaly segments identified by the depth anomaly detection logic 136, the segment labeling function 216 may generate a labeled depth image 140 comprising an updated version of the depth image 122 that includes labels that tag the one or more identified anomaly segments as identified anomaly segments, such as illustrated by the example labeled depth image 340 in FIG. 3B. As shown in FIG. 3B, the segment labeling function 216 may update the initial depth image 312 to produce the labeled depth image 340 that includes one or more segments labeled as comprising identified anomalous segments (shown at 342). In some embodiments, the segment labeling function 216 may further label segments to include metadata based on the classifications inferred by the segment classification model(s) 214. Identified anomalous segments 342 may be further labeled to indicate that they comprise optical reflections (343), large flat surfaces (344), or glass or otherwise transparent features (345), and/or labeled with other metadata that may assist in characterizing the nature of the feature and/or cause of inaccurate depth value predictions for that feature.

In some embodiments, the method may proceed with generating the updated depth image based at least on the one or more updated depth values computed for the one or more anomalous depth values. In some embodiments, a corrected depth image may be generated based at least on one or more corrected depth values computed for the one or more anomalous depth values. For example, one or more interpolated depth values may be computed for the one or more anomalous depth values based at least on a set of depth values selected from one or more segments of the depth image not identified as comprising the one or more anomalous depth values, wherein the one or more updated (e.g., corrected) depth values are based on the one or more interpolated depth values. A set of data samples may be output that include a data sample comprising the at least one stereo image pair and the corrected depth image.

As discussed with respect to FIG. 1, in some embodiments, labeled depth image(s) 140 may be applied to a depth image anomaly correction stage 134 that produces a corrected depth image 162 by applying adjustments to the depth image 122 based on the identified anomalous segments 342. The depth image anomaly correction stage 134 may include segment correction logic 138 that applies one or more correction techniques to one or more of the identified anomalous segments 342 to at least partially mitigate inaccuracies in depth values in those segments. Segment correction logic 138 may compute corrected depth values based on the context associated with an identified anomalous segment (e.g., based on depth values of adjacent non-anomalous segments, based on detected structural characteristics within the volume of space corresponding to an identified anomalous segment, and/or based on characteristics of local phenomena (e.g., lighting, reflections, glare, etc.) identified as potentially causing the inaccuracies in depth values). The depth image anomaly correction stage 134 may output a stereo image pair training data sample 160 that comprises the stereo image pair 102 and a corresponding corrected depth image 162 derived from the stereo image pair 112 by the depth image anomaly processor 130.

The one or more interpolated depth values may be applied to a surface-fitting algorithm to compute the one or more updated (e.g., corrected) depth values. Segment correction logic 138 may apply corrective functions that leverage structural geometries associated with identified anomalous segments 342, and fit interpolated depth values to surfaces using one or more surface-fitting algorithms 246 to generate the corrected depth values for corrected depth image 162. In some embodiments, a surface shape classification may be determined from metadata for an identified anomalous segment and then a corresponding shape selected by the surface-fitting algorithm(s) 246 for fitting based on the classification. In some embodiments, one or more structural constraints may be applied to the surface-fitting algorithm based on one or more contextual classifications determined from a geometry depicted in the stereo image pair. The surface-fitting algorithms 246 may be subject to one or more structural constraints based on the geometry of the overall scene as depicted in the stereo image pair 112. In some embodiments, interpolated depth values may be fitted to planes/surfaces of an architectural model to compute corrected depth values so that the position and/or orientation of those surfaces are constrained with respect to each other based on the generalized architectural model selected (e.g., a hallway model, in this example).

Generating a corrected depth image may include applying a mask to the at least one segment of the updated depth image to redact the one or more anomalous depth values to output a masked depth image. One or more operations (e.g., of the vehicle 900) may be executed based on the masked depth image. In some embodiments, the method may include determining a quality of the depth image based at least on the at least one segment of one or more anomalous depth values, and outputting an accuracy score for the machine learning model based at least on the determined quality.

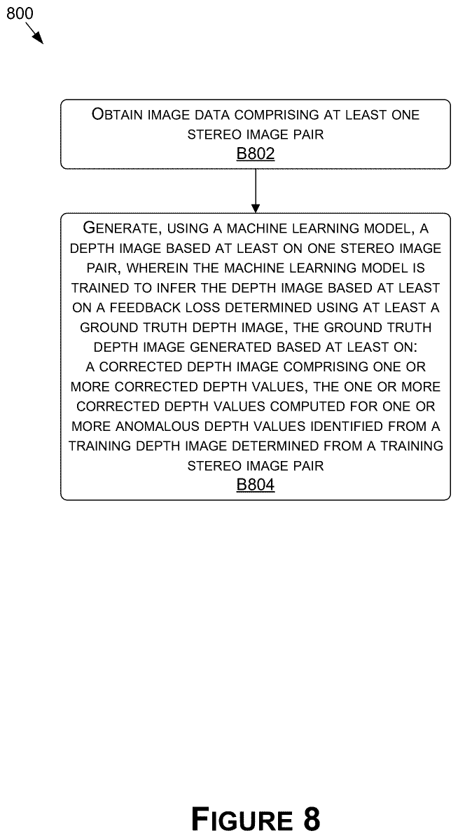

FIG. 8 is a flow diagram illustrating an example method 800 for generating a depth image from a stereo image pair, in accordance with some embodiments of the present disclosure. It should be understood that the features and elements described herein with respect to the method 800 of FIG. 8 may be used in conjunction with, in combination with, or substituted for elements of any of the other embodiments discussed herein and vice versa. Further, it should be understood that the functions, structures, and other descriptions of elements for embodiments described in FIG. 8 may apply to like or similarly named or described elements across any of the figures and/or embodiments described herein and vice versa.

Each block of method 800, described herein, comprises a computing process that may be performed using any combination of hardware, firmware, and/or software. For instance, various functions may be carried out by one or more processors (comprising processing circuitry) executing instructions stored in memory. The methods may also be embodied as computer-usable instructions stored on computer storage media. The methods may be provided by a standalone application, a service or hosted service (standalone or in combination with another hosted service), or a plug-in to another product, to name a few. In addition, method 800 is described, by way of example, with respect to the stereo anomaly detection system 100 of FIG. 1. However, these methods may additionally or alternatively be executed by any one system, or any combination of systems, including, but not limited to, those described herein.

The method 800, at block B802, includes obtaining image data comprising at least one stereo image pair. As described herein with respect to FIG. 1, in some embodiments, optical image data 110 comprising stereo image pair(s) 112 may be produced by one or more image sensors 102 (e.g., camera(s)). A stereo image pair 112 may comprise a pair of images simultaneously captured by a set of paired image sensors from offset viewpoints, and/or a pair of images captured by a single image sensor from two offset positions. Image sensor(s) 102 may include, for example, RGB cameras, IR cameras, RGB-IR cameras, stereo camera arrays, depth cameras, and/or other cameras, such as cameras described with respect to the vehicle 900 of FIGS. 9A-9D. The image sensor(s) 102 may include one or more cameras of an ego object or ego actor, such as stereo camera(s) 968, wide-view camera(s) 970 (e.g., fisheye cameras), infrared camera(s) 972, surround camera(s) 974 (e.g., 360° cameras), occupant monitoring system (OMS) sensor(s) 901, and/or long-range and/or mid-range camera(s) degree 998 of the autonomous vehicle 900 of FIGS. 9A-9D. The image sensor(s) 102 may thus be used to generate the image data 110 of a three-dimensional (3D) environment around an ego object or ego actor.

The method 800, at block B804, includes generating, using a machine learning model, a depth image based at least on the at least one stereo image pair, wherein the machine learning model is trained to infer the depth image based at least on a feedback loss determined using at least a ground truth depth image. The ground truth depth image may be generated based at least on a corrected depth image comprising one or more corrected depth values, the one or more corrected depth values computed for one or more anomalous depth values identified from a training depth image determined from a training stereo image pair. In some embodiments, one or more operations of the vehicle 900 may be executed based on the depth image, such as but not limited to operations for depth-based object detection. In some embodiments, the machine learning model may be trained as a stereo depth perception model such as described with respect to FIG. 5. For example, the machine learning model under training may generate a prediction comprising a depth image based on an input comprising a stereo image pair. The depth image and a ground truth depth image (generated based at least on a corrected depth image) may be input to a loss function that computes a loss feedback that is used to adjust the machine learning model based on one or more deviations between the depth image and the ground truth depth image. The machine learning model may be trained to operate as a stereo depth perception model based on iteratively adjusting the model while applying a series of training data samples to drive the loss feedback towards a minimum loss where the predicted depth image produced by the model is substantially similar to the corrected depth image-based ground truth image.

In some embodiments, a loss function such as loss function 510 may be used by a model accuracy scoring function 150 to compute an accuracy score or rating for judging the quality of the stereo depth perception model (e.g., model accuracy score 152) and/or for tracking improvements in the model during the course of a development process. As such, in some embodiments, the method may determine a quality of the depth image based at least on an identification of at least one segment of the depth image as comprising a set of anomalous depth values, and may output an accuracy score for the machine learning model based at least on the determined quality. In some embodiments, the method may output a set of data samples that include a data sample comprising the at least one stereo image pair and the depth image generated from the at least one stereo image pair. One or more operations (e.g., of the vehicle 900) may be executed based on the masked depth image. In some embodiments, depth images produced by the machine learning model may be stored to an image storage (e.g., a database, data store, etc.) so that they may be retrieved for subsequent analysis, used as data samples for training machine learning models, and/or other purposes.

In some embodiments, the systems and methods described herein may be performed within, or in conjunction with, a simulation environment (e.g., NVIDIA's DriveSIM) using simulated data (e.g., simulated sensor data of simulated sensors of a virtual or simulated machine). For example, simulated sensor data and/or map data may be used that includes the application of stereo image pair-derived depth measurements within the simulation environment, and may use this information to perform operations (e.g., navigating) associated with the virtual machine within the environment. These simulated operations may be used to test performance of the underlying algorithms, systems, and/or processes prior to deploying them in the real world. In some instances, the simulation may be used to generate synthetic training data—e.g., training data including regions of interest and/or subregions of interest from within the simulation. The synthetic training data (in addition to or alternatively from real-world data) may then be processed to determine geometry and/or other information related to road surfaces, for example. In any example, such as where a simulation environment is used for testing, validation, training, etc., the simulation environment and/or associated training data may be rendered or otherwise generated using one or more light transport algorithms—such as ray-tracing and/or path-tracing algorithms. In some embodiments, the simulation environment and/or one or more objects, features, or components thereof may be generated or managed within a three-dimensional (3D) content collaboration platform (e.g., NVIDIA's Omniverse) for industrial digitalization, generative physical artificial intelligence (AI), and/or other use cases, applications, or services. For example, the content collaboration platform or system may include a system for using or developing a universal scene descriptor (USD) (e.g., OpenUSD) data for managing objects, features, scenes, etc., within a simulated environment, digital environment, etc. The platform may include real physics simulation, such as using NVIDIA's PhysX SDK, in order to simulate real physics and physical interactions with simulations hosted by the platform. The platform may integrate OpenUSD along with ray tracing/path tracing/light transport simulation (e.g., NVIDIA's RTX rendering technologies) into software tools and simulation workflows for building, training, deploying, or testing AI systems—such as systems for testing, validating, training (e.g., machine learning models, neural networks, etc.), and/or other tasks related to automotive, robot, machine, or other applications.

In some embodiments, teleoperation or remote control of a vehicle or other machine may be performed using a remote control or teleoperation system. For example, the systems and methods described herein may be used to produce depth information related to animate or static objects, hazards, etc., which may be used or included in a visualization or mapping of an environment to aid a remote operator in controlling—or providing waypoints or other indications of control or navigation—an autonomous or semi-autonomous machine through an environment.

In some embodiments, the system and methods described herein may be deployed in an in-vehicle infotainment (IVI) system or in-cabin experience (IX) application. For example, the infotainment system within a vehicle (e.g., cars, trucks, drones, construction equipment, robots, semi-autonomous vehicles, or autonomous vehicles) may include one or more onboard processors (e.g., CPUs, GPUs, hardware-based deep learning accelerators (DLAs), hardware-based programmable vision accelerators (PVAs)—which may include one or more vector processing units (VPUs), direct memory access (DMA) systems, and/or pixel processing engines (PPEs), hardware-based optical flow accelerators (OFAs), SoCs, etc.) and memory and/or storage (e.g., for storing control algorithms, sensor data, and one or more machine learning models). and memory and/or storage (e.g., for storing entertainment content, navigation data, and user preferences). The system may use these processors to execute one or more machine learning to enable features such as occupant monitoring, gesture recognition, and real-time communication with other services through network connectivity. The in-vehicle infotainment system may also use natural language processing (NLP) models to enable voice-based interaction. The one or more machine learning models may be stored locally or accessed through one or more APIs that connect to cloud services, enabling the system to process requests in real time or near real-time.

In some embodiments, the system and methods described herein may be deployed in a robotics application. For example, a robot or robotic system may include one or more onboard processors (e.g., CPUs, GPUs, hardware-based deep learning accelerators (DLAs), hardware-based programmable vision accelerators (PVAs)—which may include one or more vector processing units (VPUs), direct memory access (DMA) systems, and/or pixel processing engines (PPEs), hardware-based optical flow accelerators (OFAs), SoCs, etc.) and memory and/or storage (e.g., for storing control algorithms, sensor data, and one or more machine learning models). The robotic system may use these processors to execute one or more machine learning models (e.g., language models) that allow it to perform complex tasks autonomously or semi-autonomously, such as interacting with and/or manipulating static and/or dynamic objects, or navigating environments using sensors such as cameras, LiDAR, RADAR, ultrasonic sensors, and more. The system may use sensor fusion techniques to combine data from multiple sensors (e.g., cameras, infrared, LiDAR, RADAR, accelerometers) to create a comprehensive model of the robot's surroundings. This data may be processed locally on the robot or sent to remote servers for more computationally intensive tasks, such as 3D mapping or SLAM (Simultaneous Localization and Mapping). In one or more embodiments, data from individual robots (e.g., sensor data, task status, or environmental conditions) may be uploaded to the cloud, where centralized AI models can analyze and distribute optimized commands to an entire fleet. In some embodiments, the machine learning model(s) (e.g., language models, VLMs, LLMs, MMLMs, diffusion models, NeRF models, DNNs, etc.) described herein may be used to allow the robot to perceive and reason about the environment and/or communicate with one or more other robots and/or persons in an environment. In some embodiments, the robot may communicate (e.g., using one or more network interface cards (NICs) and/or data processing units (DPUs)) with one or more locally hosted servers/computing devices and/or with one or more remotely located servers/computing devices (e.g., in one or more data centers).

In some examples, the machine learning model(s) (e.g., deep neural networks, language models, LLMs, VLMs, multi-modal language models, perception models, tracking models, fusion models, transformer models, diffusion models, encoder-only models, decoder-only models, encoder-decoder models, neural rendering field (NERF) models, etc.) described herein may be packaged as a microservice—such an inference microservice (e.g., NVIDIA NIMs)—which may include a container (e.g., an operating system (OS)-level virtualization package) that may include an application programming interface (API) layer, a server layer, a runtime layer, and/or a model “engine.” For example, the inference microservice may include the container itself and the model(s) (e.g., weights and biases). In some instances, such as where the machine learning model(s) is small enough (e.g., has a small enough number of parameters), the model(s) may be included within the container itself. In other examples—such as where the model(s) is large—the model(s) may be hosted/stored in the cloud (e.g., in a data center) and/or may be hosted on-premises and/or at the edge (e.g., on a local server or computing device, but outside of the container). In such embodiments, the model(s) may be accessible via one or more APIs-such as REST APIs. As such, and in some embodiments, the machine learning model(s) described herein may be deployed as an inference microservice to accelerate deployment of a model(s) on any cloud, data center, or edge computing system, while ensuring the data is secure. For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications—such as NVIDIA's TensorRT), and/or enterprise management data for telemetry (e.g., including identity, metrics, health checks, and/or monitoring). The machine learning model(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the machine learning model(s) (e.g., that has been optimized for high performance inference), an inference runtime software to execute the machine learning model(s) and provide outputs/responses to inputs (e.g., user queries, prompts, etc.), and enterprise management software to provide health checks, identity, and/or other monitoring. In some embodiments, the inference microservice may include software to perform in-place replacement and/or updating to the machine learning model(s). When replacing or updating, the software that performs the replacement/updating may maintain user configurations of the inference runtime software and enterprise management software.

The systems and methods described herein may be used by, without limitation, non-autonomous vehicles, semi-autonomous vehicles (e.g., in one or more adaptive driver assistance systems (ADAS)), piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, trains, underwater craft, remotely operated vehicles such as drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing, generative AI, and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems implementing one or more language models—such as one or more large language models (LLMs) and/or one or more vision language models (VLMs), systems for performing light transport simulation, systems for performing collaborative content creation for 3D assets, systems implemented at least partially using cloud computing resources, and/or other types of systems.

### Example Autonomous Vehicle

FIG. 9A is an illustration of an example autonomous vehicle 900, in accordance with some embodiments of the present disclosure. The autonomous vehicle 900 (alternatively referred to herein as the “vehicle 900”) may include, without limitation, a passenger vehicle, such as a car, a truck, a bus, a first responder vehicle, a shuttle, an electric or motorized bicycle, a motorcycle, a fire truck, a police vehicle, an ambulance, a boat, a construction vehicle, an underwater craft, a robotic vehicle, a drone, an airplane, a vehicle coupled to a trailer (e.g., a semi-tractor-trailer truck used for hauling cargo), and/or another type of vehicle (e.g., that is unmanned and/or that accommodates one or more passengers). Autonomous vehicles are generally described in terms of automation levels, defined by the National Highway Traffic Safety Administration (NHTSA), a division of the US Department of Transportation, and the Society of Automotive Engineers (SAE) “Taxonomy and Definitions for Terms Related to Driving Automation Systems for On-Road Motor Vehicles” (Standard No. J3016-201806, published on Jun. 15, 2018, Standard No. J3016-201609, published on Sep. 30, 2016, and previous and future versions of this standard). The vehicle 900 may be capable of functionality in accordance with one or more of Level 3-Level 5 of the autonomous driving levels. The vehicle 900 may be capable of functionality in accordance with one or more of Level 1-Level 5 of the autonomous driving levels. For example, the vehicle 900 may be capable of driver assistance (Level 1), partial automation (Level 2), conditional automation (Level 3), high automation (Level 4), and/or full automation (Level 5), depending on the embodiment. The term “autonomous,” as used herein, may include any and/or all types of autonomy for the vehicle 900 or other machine, such as being fully autonomous, being highly autonomous, being conditionally autonomous, being partially autonomous, providing assistive autonomy, being semi-autonomous, being primarily autonomous, or other designation.

The vehicle 900 may include components such as a chassis, a vehicle body, wheels (e.g., 2, 4, 6, 8, 18, etc.), tires, axles, and other components of a vehicle. The vehicle 900 may include a propulsion system 950, such as an internal combustion engine, hybrid electric power plant, an all-electric engine, and/or another propulsion system type. The propulsion system 950 may be connected to a drive train of the vehicle 900, which may include a transmission, to allow the propulsion of the vehicle 900. The propulsion system 950 may be controlled in response to receiving signals from the throttle/accelerator 952.

A steering system 954, which may include a steering wheel, may be used to steer the vehicle 900 (e.g., along a desired path or route) when the propulsion system 950 is operating (e.g., when the vehicle is in motion). The steering system 954 may receive signals from a steering actuator 956. The steering wheel may be optional for full automation (Level 5) functionality.

The brake sensor system 946 may be used to operate the vehicle brakes in response to receiving signals from the brake actuators 948 and/or brake sensors.

Controller(s) 936, which may include one or more system on chips (SoCs) 904 (FIG. 9C) and/or GPU(s), may provide signals (e.g., representative of commands) to one or more components and/or systems of the vehicle 900. For example, the controller(s) may send signals to operate the vehicle brakes via one or more brake actuators 948, to operate the steering system 954 via one or more steering actuators 956, to operate the propulsion system 950 via one or more throttle/accelerators 952. The controller(s) 936 may include one or more onboard (e.g., integrated) computing devices (e.g., supercomputers) that process sensor signals, and output operation commands (e.g., signals representing commands) to allow autonomous driving and/or to assist a human driver in driving the vehicle 900. The controller(s) 936 may include a first controller 936 for autonomous driving functions, a second controller 936 for functional safety functions, a third controller 936 for artificial intelligence functionality (e.g., computer vision), a fourth controller 936 for infotainment functionality, a fifth controller 936 for redundancy in emergency conditions, and/or other controllers. In some examples, a single controller 936 may handle two or more of the above functionalities, two or more controllers 936 may handle a single functionality, and/or any combination thereof.

The controller(s) 936 may provide the signals for controlling one or more components and/or systems of the vehicle 900 in response to sensor data received from one or more sensors (e.g., sensor inputs). The sensor data may be received from, for example and without limitation, global navigation satellite systems (“GNSS”) sensor(s) 958 (e.g., Global Positioning System sensor(s)), RADAR sensor(s) 960, ultrasonic sensor(s) 962, LiDAR sensor(s) 964, inertial measurement unit (IMU) sensor(s) 966 (e.g., accelerometer(s), gyroscope(s), magnetic compass(es), magnetometer(s), etc.), microphone(s) 996, stereo camera(s) 968, wide-view camera(s) 970 (e.g., fisheye cameras), infrared camera(s) 972, surround camera(s) 974 (e.g., 360 degree cameras), long-range and/or mid-range camera(s) 998, speed sensor(s) 944 (e.g., for measuring the speed of the vehicle 900), vibration sensor(s) 942, steering sensor(s) 940, brake sensor(s) (e.g., as part of the brake sensor system 946), one or more occupant monitoring system (OMS) sensor(s) 901 (e.g., one or more interior cameras), and/or other sensor types. In some embodiments, image data 110—including stereo image pair(s) 112—may comprise image data captured by one or more of the sensors described with respect to FIG. 9A. In some embodiments, the controller(s) 936 may provide the signals for controlling one or more components and/or systems of the vehicle 900 based at least in part on corrected depth image(s) 162 produced by a depth image anomaly processor 130 as described herein.

One or more of the controller(s) 936 may receive inputs (e.g., represented by input data) from an instrument cluster 932 of the vehicle 900 and provide outputs (e.g., represented by output data, display data, etc.) via a human-machine interface (HMI) display 934, an audible annunciator, a loudspeaker, and/or via other components of the vehicle 900. The outputs may include information such as vehicle velocity, speed, time, map data (e.g., the High Definition (“HD”) map 922 of FIG. 9C), location data (e.g., the vehicle's 900 location, such as on a map), direction, location of other vehicles (e.g., an occupancy grid), information about objects and status of objects as perceived by the controller(s) 936, etc. For example, the HMI display 934 may display information about the presence of one or more objects (e.g., a street sign, caution sign, traffic light changing, etc.), and/or information about driving maneuvers the vehicle has made, is making, or will make (e.g., changing lanes now, taking exit 34B in two miles, etc.). In some embodiments, HMI 124 may comprise or be implemented using the HMI 934.

The vehicle 900 further includes a network interface 924 which may use one or more wireless antenna(s) 926 and/or modem(s) to communicate over one or more networks. For example, the network interface 924 may be capable of communication over Long-Term Evolution (“LTE”), Wideband Code Division Multiple Access (“WCDMA”), Universal Mobile Telecommunications System (“UMTS”), Global System for Mobile communication (“GSM”), IMT-CDMA Multi-Carrier (“CDMA2000”), etc. The wireless antenna(s) 926 may also allow communication between objects in the environment (e.g., vehicles, mobile devices, etc.), using local area network(s), such as Bluetooth, Bluetooth Low Energy (“LE”), Z-Wave, ZigBee, etc., and/or low power wide-area network(s) (“LPWANs”), such as LoRaWAN, SigFox, etc.

FIG. 9B is an example of camera locations and fields of view for the example autonomous vehicle 900 of FIG. 9A, in accordance with some embodiments of the present disclosure. The cameras and respective fields of view are one example embodiment and are not intended to be limiting. For example, additional and/or alternative cameras may be included and/or the cameras may be located at different locations on the vehicle 900.

The camera types for the cameras may include, but are not limited to, digital cameras that may be adapted for use with the components and/or systems of the vehicle 900. The camera(s) may operate at automotive safety integrity level (ASIL) B and/or at another ASIL. The camera types may be capable of any image capture rate, such as 60 frames per second (fps), 120 fps, 240 fps, etc., depending on the embodiment. The cameras may be capable of using rolling shutters, global shutters, another type of shutter, or a combination thereof. In some examples, the color filter array may include a red clear clear clear (RCCC) color filter array, a red clear clear blue (RCCB) color filter array, a red blue green clear (RBGC) color filter array, a Foveon X3 color filter array, a Bayer sensors (RGGB) color filter array, a monochrome sensor color filter array, and/or another type of color filter array. In some embodiments, clear pixel cameras, such as cameras with an RCCC, an RCCB, and/or an RBGC color filter array, may be used in an effort to increase light sensitivity.

In some examples, one or more of the camera(s) may be used to perform advanced driver assistance systems (ADAS) functions (e.g., as part of a redundant or fail-safe design). For example, a Multi-Function Mono Camera may be installed to provide functions including lane departure warning, traffic sign assist and intelligent headlamp control. One or more of the camera(s) (e.g., all of the cameras) may record and provide image data (e.g., video) simultaneously.

One or more of the cameras may be mounted in a mounting assembly, such as a custom designed (three dimensional (“3D”) printed) assembly, in order to cut out stray light and reflections from within the car (e.g., reflections from the dashboard reflected in the windshield mirrors) which may interfere with the camera's image data capture abilities. With reference to wing-mirror mounting assemblies, the wing-mirror assemblies may be custom 3D printed so that the camera mounting plate matches the shape of the wing-mirror. In some examples, the camera(s) may be integrated into the wing-mirror. For side-view cameras, the camera(s) may also be integrated within the four pillars at each corner of the cabin.

Cameras with a field of view that include portions of the environment in front of the vehicle 900 (e.g., front-facing cameras) may be used for surround view, to help identify forward facing paths and obstacles, as well aid in, with the help of one or more controllers 936 and/or control SoCs, providing information critical to generating an occupancy grid and/or determining the preferred vehicle paths. Front-facing cameras may be used to perform many of the same ADAS functions as LiDAR, including emergency braking, pedestrian detection, and collision avoidance. Front-facing cameras may also be used for ADAS functions and systems including Lane Departure Warnings (“LDW”), Autonomous Cruise Control (“ACC”), and/or other functions such as traffic sign recognition.

A variety of cameras may be used in a front-facing configuration, including, for example, a monocular camera platform that includes a complementary metal oxide semiconductor (“CMOS”) color imager. Another example may be a wide-view camera(s) 970 that may be used to perceive objects coming into view from the periphery (e.g., pedestrians, crossing traffic or bicycles). Although only one wide-view camera is illustrated in FIG. 9B, there may be any number (including zero) of wide-view cameras 970 on the vehicle 900. In addition, any number of long-range camera(s) 998 (e.g., a long-view stereo camera pair) may be used for depth-based object detection, especially for objects for which a neural network has not yet been trained. The long-range camera(s) 998 may also be used for object detection and classification, as well as basic object tracking.

Any number of stereo cameras 968 may also be included in a front-facing configuration. In at least one embodiment, one or more of stereo camera(s) 968 may include an integrated control unit comprising a scalable processing unit, which may provide a programmable logic (“FPGA”) and a multi-core micro-processor with an integrated Controller Area Network (“CAN”) or Ethernet interface on a single chip. Such a unit may be used to generate a 3D map of the vehicle's environment, including a distance estimate for all the points in the image. An alternative stereo camera(s) 968 may include a compact stereo vision sensor(s) that may include two camera lenses (one each on the left and right) and an image processing chip that may measure the distance from the vehicle to the target object and use the generated information (e.g., metadata) to activate the autonomous emergency braking and lane departure warning functions. Other types of stereo camera(s) 968 may be used in addition to, or alternatively from, those described herein. In some embodiments, optical image sensor(s) 102 are implemented using one or more stereo cameras 968.

Cameras with a field of view that include portions of the environment to the side of the vehicle 900 (e.g., side-view cameras) may be used for surround view, providing information used to create and update the occupancy grid, as well as to generate side impact collision warnings. For example, surround camera(s) 974 (e.g., four surround cameras 974 as illustrated in FIG. 9B) may be positioned to on the vehicle 900. The surround camera(s) 974 may include wide-view camera(s) 970, fisheye camera(s), 360 degree camera(s), and/or the like. Four example, four fisheye cameras may be positioned on the vehicle's front, rear, and sides. In an alternative arrangement, the vehicle may use three surround camera(s) 974 (e.g., left, right, and rear), and may leverage one or more other camera(s) (e.g., a forward-facing camera) as a fourth surround view camera.

Cameras with a field of view that include portions of the environment to the rear of the vehicle 900 (e.g., rear-view cameras) may be used for park assistance, surround view, rear collision warnings, and creating and updating the occupancy grid. A wide variety of cameras may be used including, but not limited to, cameras that are also suitable as a front-facing camera(s) (e.g., long-range and/or mid-range camera(s) 998, stereo camera(s) 968), infrared camera(s) 972, etc.), as described herein.

Cameras with a field of view that include portions of the interior environment within the cabin of the vehicle 900 (e.g., one or more OMS sensor(s) 901) may be used as part of an occupant monitoring system (OMS) such as, but not limited to, a driver monitoring system (DMS). For example, OMS sensors (e.g., the OMS sensor(s) 901) may be used (e.g., by the controller(s) 936) to track an occupant's and/or driver's gaze direction, head pose, and/or blinking. This gaze information may be used to determine a level of attentiveness of the occupant or driver (e.g., to detect drowsiness, fatigue, and/or distraction), and/or to take responsive action to prevent harm to the occupant or operator. In some embodiments, data from OMS sensors may be used to allow gaze-controlled operations triggered by driver and/or non-driver occupants such as, but not limited to, adjusting cabin temperature and/or airflow, opening and closing windows, controlling cabin lighting, controlling entertainment systems, adjusting mirrors, adjusting seat positions, and/or other operations. In some embodiments, an OMS may be used for applications such as determining when objects and/or occupants have been left behind in a vehicle cabin (e.g., by detecting occupant presence after the driver exits the vehicle).

FIG. 9C is a block diagram of an example system architecture for the example autonomous vehicle 900 of FIG. 9A, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

Each of the components, features, and systems of the vehicle 900 in FIG. 9C are illustrated as being connected via bus 902. The bus 902 may include a Controller Area Network (CAN) data interface (alternatively referred to herein as a “CAN bus”). A CAN may be a network inside the vehicle 900 used to aid in control of various features and functionality of the vehicle 900, such as actuation of brakes, acceleration, braking, steering, windshield wipers, etc. A CAN bus may be configured to have dozens or even hundreds of nodes, each with its own unique identifier (e.g., a CAN ID). The CAN bus may be read to find steering wheel angle, ground speed, engine revolutions per minute (RPMs), button positions, and/or other vehicle status indicators. The CAN bus may be ASIL B compliant.

Although the bus 902 is described herein as being a CAN bus, this is not intended to be limiting. For example, in addition to, or alternatively from, the CAN bus, FlexRay and/or Ethernet may be used. Additionally, although a single line is used to represent the bus 902, this is not intended to be limiting. For example, there may be any number of busses 902, which may include one or more CAN busses, one or more FlexRay busses, one or more Ethernet busses, and/or one or more other types of busses using a different protocol. In some examples, two or more busses 902 may be used to perform different functions, and/or may be used for redundancy. For example, a first bus 902 may be used for collision avoidance functionality and a second bus 902 may be used for actuation control. In any example, each bus 902 may communicate with any of the components of the vehicle 900, and two or more busses 902 may communicate with the same components. In some examples, each SoC 904, each controller 936, and/or each computer within the vehicle may have access to the same input data (e.g., inputs from sensors of the vehicle 900), and may be connected to a common bus, such the CAN bus.

The vehicle 900 may include one or more controller(s) 936, such as those described herein with respect to FIG. 9A. The controller(s) 936 may be used for a variety of functions. The controller(s) 936 may be coupled to any of the various other components and systems of the vehicle 900, and may be used for control of the vehicle 900, artificial intelligence of the vehicle 900, infotainment for the vehicle 900, and/or the like.

The vehicle 900 may include a system(s) on a chip (SoC) 904. The SoC 904 may include CPU(s) 906, GPU(s) 908, processor(s) 910, cache(s) 912, accelerator(s) 914, data store(s) 916, and/or other components and features not illustrated. The SoC(s) 904 may be used to control the vehicle 900 in a variety of platforms and systems. For example, the SoC(s) 904 may be combined in a system (e.g., the system of the vehicle 900) with an HD map 922 which may obtain map refreshes and/or updates via a network interface 924 from one or more servers (e.g., server(s) 978 of FIG. 9D). In some embodiments, one or more functions of the depth image anomaly processor 130, depth image anomaly identification data 132 and/or depth image anomaly correction state 134 may be implemented at least in part using code executed by the SoC(s) 904, CPU(s) 906 and/or GPU(s) 908.

The CPU(s) 906 may include a CPU cluster or CPU complex (alternatively referred to herein as a “CCPLEX”). The CPU(s) 906 may include multiple cores and/or L2 caches. For example, in some embodiments, the CPU(s) 906 may include eight cores in a coherent multi-processor configuration. In some embodiments, the CPU(s) 906 may include four dual-core clusters where each cluster has a dedicated L2 cache (e.g., a 2 MB L2 cache). The CPU(s) 906 (e.g., the CCPLEX) may be configured to support simultaneous cluster operation allowing any combination of the clusters of the CPU(s) 906 to be active at any given time.

The CPU(s) 906 may implement power management capabilities that include one or more of the following features: individual hardware blocks may be clock-gated automatically when idle to save dynamic power; each core clock may be gated when the core is not actively executing instructions due to execution of WFI/WFE instructions; each core may be independently power-gated; each core cluster may be independently clock-gated when all cores are clock-gated or power-gated; and/or each core cluster may be independently power-gated when all cores are power-gated. The CPU(s) 906 may further implement an enhanced algorithm for managing power states, where allowed power states and expected wakeup times are specified, and the hardware/microcode determines the best power state to enter for the core, cluster, and CCPLEX. The processing cores may support simplified power state entry sequences in software with the work offloaded to microcode.

The GPU(s) 908 may include an integrated GPU (alternatively referred to herein as an “iGPU”). The GPU(s) 908 may be programmable and may be efficient for parallel workloads. The GPU(s) 908, in some examples, may use an enhanced tensor instruction set. The GPU(s) 908 may include one or more streaming microprocessors, where each streaming microprocessor may include an L1 cache (e.g., an L1 cache with at least 96 KB storage capacity), and two or more of the streaming microprocessors may share an L2 cache (e.g., an L2 cache with a 512 KB storage capacity). In some embodiments, the GPU(s) 908 may include at least eight streaming microprocessors. The GPU(s) 908 may use compute application programming interface(s) (API(s)). In addition, the GPU(s) 908 may use one or more parallel computing platforms and/or programming models (e.g., NVIDIA's CUDA).

The GPU(s) 908 may be power-optimized for best performance in automotive and embedded use cases. For example, the GPU(s) 908 may be fabricated on a Fin field-effect transistor (FinFET). However, this is not intended to be limiting and the GPU(s) 908 may be fabricated using other semiconductor manufacturing processes. Each streaming microprocessor may incorporate a number of mixed-precision processing cores partitioned into multiple blocks. For example, and without limitation, 64 PF32 cores and 32 PF 64 cores may be partitioned into four processing blocks. In such an example, each processing block may be allocated 16 FP32 cores, 8 FP64 cores, 16 INT32 cores, two mixed-precision NVIDIA TENSOR COREs for deep learning matrix arithmetic, an L0 instruction cache, a warp scheduler, a dispatch unit, and/or a 64 KB register file. In addition, the streaming microprocessors may include independent parallel integer and floating-point data paths to provide for efficient execution of workloads with a mix of computation and addressing calculations. The streaming microprocessors may include independent thread scheduling capability to allow finer-grain synchronization and cooperation between parallel threads. The streaming microprocessors may include a combined L1 data cache and shared memory unit in order to improve performance while simplifying programming.

The GPU(s) 908 may include a high bandwidth memory (HBM) and/or a 16 GB HBM2 memory subsystem to provide, in some examples, about 900 GB/second peak memory bandwidth. In some examples, in addition to, or alternatively from, the HBM memory, a synchronous graphics random-access memory (SGRAM) may be used, such as a graphics double data rate type five synchronous random-access memory (GDDR5).

The GPU(s) 908 may include unified memory technology including access counters to allow for more accurate migration of memory pages to the processor that accesses them most frequently, thereby improving efficiency for memory ranges shared between processors. In some examples, address translation services (ATS) support may be used to allow the GPU(s) 908 to access the CPU(s) 906 page tables directly. In such examples, when the GPU(s) 908 memory management unit (MMU) experiences a miss, an address translation request may be transmitted to the CPU(s) 906. In response, the CPU(s) 906 may look in its page tables for the virtual-to-physical mapping for the address and transmits the translation back to the GPU(s) 908. As such, unified memory technology may allow a single unified virtual address space for memory of both the CPU(s) 906 and the GPU(s) 908, thereby simplifying the GPU(s) 908 programming and porting of applications to the GPU(s) 908.

In addition, the GPU(s) 908 may include an access counter that may keep track of the frequency of access of the GPU(s) 908 to memory of other processors. The access counter may help ensure that memory pages are moved to the physical memory of the processor that is accessing the pages most frequently.

The SoC(s) 904 may include any number of cache(s) 912, including those described herein. For example, the cache(s) 912 may include an L3 cache that is available to both the CPU(s) 906 and the GPU(s) 908 (e.g., that is connected both the CPU(s) 906 and the GPU(s) 908). The cache(s) 912 may include a write-back cache that may keep track of states of lines, such as by using a cache coherence protocol (e.g., MEI, MESI, MSI, etc.). The L3 cache may include 4 MB or more, depending on the embodiment, although smaller cache sizes may be used.

The SoC(s) 904 may include an arithmetic logic unit(s) (ALU(s)) which may be leveraged in performing processing with respect to any of the variety of tasks or operations of the vehicle 900—such as processing DNNs. In addition, the SoC(s) 904 may include a floating point unit(s) (FPU(s))—or other math coprocessor or numeric coprocessor types—for performing mathematical operations within the system. For example, the SoC(s) 904 may include one or more FPUs integrated as execution units within a CPU(s) 906 and/or GPU(s) 908.

The SoC(s) 904 may include one or more accelerators 914 (e.g., hardware accelerators, software accelerators, or a combination thereof). For example, the SoC(s) 904 may include a hardware acceleration cluster that may include optimized hardware accelerators and/or large on-chip memory. The large on-chip memory (e.g., 4MB of SRAM), may allow the hardware acceleration cluster to accelerate neural networks and other calculations. The hardware acceleration cluster may be used to complement the GPU(s) 908 and to off-load some of the tasks of the GPU(s) 908 (e.g., to free up more cycles of the GPU(s) 908 for performing other tasks). As an example, the accelerator(s) 914 may be used for targeted workloads (e.g., perception, convolutional neural networks (CNNs), etc.) that are stable enough to be amenable to acceleration. The term “CNN,” as used herein, may include all types of CNNs, including region-based or regional convolutional neural networks (RCNNs) and Fast RCNNs (e.g., as used for object detection).

The accelerator(s) 914 (e.g., the hardware acceleration cluster) may include a deep learning accelerator(s) (DLA). The DLA(s) may include one or more Tensor processing units (TPUs) that may be configured to provide an additional ten trillion operations per second for deep learning applications and inferencing. The TPUs may be accelerators configured to, and optimized for, performing image processing functions (e.g., for CNNs, RCNNs, etc.). The DLA(s) may further be optimized for a specific set of neural network types and floating point operations, as well as inferencing. The design of the DLA(s) may provide more performance per millimeter than a general-purpose GPU, and vastly exceeds the performance of a CPU. The TPU(s) may perform several functions, including a single-instance convolution function, supporting, for example, INT8, INT16, and FP16 data types for both features and weights, as well as post-processor functions.

The DLA(s) may quickly and efficiently execute neural networks, especially CNNs, on processed or unprocessed data for any of a variety of functions, including, for example and without limitation: a CNN for object identification and detection using data from camera sensors; a CNN for distance estimation using data from camera sensors; a CNN for emergency vehicle detection and identification and detection using data from microphones; a CNN for facial recognition and vehicle owner identification using data from camera sensors; and/or a CNN for security and/or safety related events.

The DLA(s) may perform any function of the GPU(s) 908, and by using an inference accelerator, for example, a designer may target either the DLA(s) or the GPU(s) 908 for any function. For example, the designer may focus processing of CNNs and floating point operations on the DLA(s) and leave other functions to the GPU(s) 908 and/or other accelerator(s) 914.

The accelerator(s) 914 (e.g., the hardware acceleration cluster) may include a programmable vision accelerator(s) (PVA), which may alternatively be referred to herein as a computer vision accelerator. The PVA(s) may be designed and configured to accelerate computer vision algorithms for the advanced driver assistance systems (ADAS), autonomous driving, and/or augmented reality (AR) and/or virtual reality (VR) applications. The PVA(s) may provide a balance between performance and flexibility. For example, each PVA(s) may include, for example and without limitation, any number of reduced instruction set computer (RISC) cores, direct memory access (DMA), and/or any number of vector processors.

The RISC cores may interact with image sensors (e.g., the image sensors of any of the cameras described herein), image signal processor(s), and/or the like. Each of the RISC cores may include any amount of memory. The RISC cores may use any of a number of protocols, depending on the embodiment. In some examples, the RISC cores may execute a real-time operating system (RTOS). The RISC cores may be implemented using one or more integrated circuit devices, application specific integrated circuits (ASICs), and/or memory devices. For example, the RISC cores may include an instruction cache and/or a tightly coupled RAM.

The DMA may allow components of the PVA(s) to access the system memory independently of the CPU(s) 906. The DMA may support any number of features used to provide optimization to the PVA including, but not limited to, supporting multi-dimensional addressing and/or circular addressing. In some examples, the DMA may support up to six or more dimensions of addressing, which may include block width, block height, block depth, horizontal block stepping, vertical block stepping, and/or depth stepping.

The vector processors may be programmable processors that may be designed to efficiently and flexibly execute programming for computer vision algorithms and provide signal processing capabilities. In some examples, the PVA may include a PVA core and two vector processing subsystem partitions. The PVA core may include a processor subsystem, DMA engine(s) (e.g., two DMA engines), and/or other peripherals. The vector processing subsystem may operate as the primary processing engine of the PVA, and may include a vector processing unit (VPU), an instruction cache, and/or vector memory (e.g., VMEM). A VPU core may include a digital signal processor such as, for example, a single instruction, multiple data (SIMD), very long instruction word (VLIW) digital signal processor. The combination of the SIMD and VLIW may enhance throughput and speed.

Each of the vector processors may include an instruction cache and may be coupled to dedicated memory. As a result, in some examples, each of the vector processors may be configured to execute independently of the other vector processors. In other examples, the vector processors that are included in a particular PVA may be configured to employ data parallelism. For example, in some embodiments, the plurality of vector processors included in a single PVA may execute the same computer vision algorithm, but on different regions of an image. In other examples, the vector processors included in a particular PVA may simultaneously execute different computer vision algorithms, on the same image, or even execute different algorithms on sequential images or portions of an image. Among other things, any number of PVAs may be included in the hardware acceleration cluster and any number of vector processors may be included in each of the PVAs. In addition, the PVA(s) may include additional error correcting code (ECC) memory, to enhance overall system safety.

The accelerator(s) 914 (e.g., the hardware acceleration cluster) may include a computer vision network on-chip and SRAM, for providing a high-bandwidth, low latency SRAM for the accelerator(s) 914. In some examples, the on-chip memory may include at least 4 MB SRAM, consisting of, for example and without limitation, eight field-configurable memory blocks, that may be accessible by both the PVA and the DLA. Each pair of memory blocks may include an advanced peripheral bus (APB) interface, configuration circuitry, a controller, and a multiplexer. Any type of memory may be used. The PVA and DLA may access the memory via a backbone that provides the PVA and DLA with high-speed access to memory. The backbone may include a computer vision network on-chip that interconnects the PVA and the DLA to the memory (e.g., using the APB).

The computer vision network on-chip may include an interface that determines, before transmission of any control signal/address/data, that both the PVA and the DLA provide ready and valid signals. Such an interface may provide for separate phases and separate channels for transmitting control signals/addresses/data, as well as burst-type communications for continuous data transfer. This type of interface may comply with ISO 26262 or IEC 61508 standards, although other standards and protocols may be used.

In some examples, the SoC(s) 904 may include a real-time ray-tracing hardware accelerator, such as described in U.S. patent application Ser. No. 16/101,232, filed on Aug. 10, 2018. The real-time ray-tracing hardware accelerator may be used to quickly and efficiently determine the positions and extents of objects (e.g., within a world model), to generate real-time visualization simulations, for RADAR signal interpretation, for sound propagation synthesis and/or analysis, for simulation of SONAR systems, for general wave propagation simulation, for comparison to LiDAR data for purposes of localization and/or other functions, and/or for other uses. In some embodiments, one or more tree traversal units (TTUs) may be used for executing one or more ray-tracing related operations.

The accelerator(s) 914 (e.g., the hardware accelerator cluster) have a wide array of uses for autonomous driving. The PVA may be a programmable vision accelerator that may be used for key processing stages in ADAS and autonomous vehicles. The PVA's capabilities are a good match for algorithmic domains needing predictable processing, at low power and low latency. As such, the PVA performs well on semi-dense or dense regular computation, even on small data sets, which need predictable run-times with low latency and low power. Thus, in the context of platforms for autonomous vehicles, the PVAs are designed to run classic computer vision algorithms, as they are efficient at object detection and operating on integer math.

For example, according to one embodiment of the technology, the PVA is used to perform computer stereo vision. A semi-global matching-based algorithm may be used in some examples, although this is not intended to be limiting. Many applications for Level 3-5 autonomous driving require motion estimation/stereo matching on-the-fly (e.g., structure from motion, pedestrian recognition, lane detection, etc.). The PVA may perform computer stereo vision function on inputs from two monocular cameras.

In some examples, the PVA may be used to perform dense optical flow. According to process raw RADAR data (e.g., using a 4D Fast Fourier Transform) to provide Processed RADAR. In other examples, the PVA is used for time of flight depth processing, by processing raw time of flight data to provide processed time of flight data, for example.

The DLA may be used to run any type of network to enhance control and driving safety, including for example, a neural network that outputs a measure of confidence for each object detection. Such a confidence value may be interpreted as a probability, or as providing a relative “weight” of each detection compared to other detections. This confidence value enables the system to make further decisions regarding which detections should be considered as true positive detections rather than false positive detections. For example, the system may set a threshold value for the confidence and consider only the detections exceeding the threshold value as true positive detections. In an automatic emergency braking (AEB) system, false positive detections would cause the vehicle to automatically perform emergency braking, which is obviously undesirable. Therefore, only the most confident detections should be considered as triggers for AEB. The DLA may run a neural network for regressing the confidence value. The neural network may take as its input at least some subset of parameters, such as bounding box dimensions, ground plane estimate obtained (e.g. from another subsystem), inertial measurement unit (IMU) sensor 966 output that correlates with the vehicle 900 orientation, distance, 3D location estimates of the object obtained from the neural network and/or other sensors (e.g., LiDAR sensor(s) 964 or RADAR sensor(s) 960), among others.

The SoC(s) 904 may include data store(s) 916 (e.g., memory). The data store(s) 916 may be on-chip memory of the SoC(s) 904, which may store neural networks to be executed on the GPU and/or the DLA. In some examples, the data store(s) 916 may be large enough in capacity to store multiple instances of neural networks for redundancy and safety. The data store(s) 916 may comprise L2 or L3 cache(s) 912. Reference to the data store(s) 916 may include reference to the memory associated with the PVA, DLA, and/or other accelerator(s) 914, as described herein.

The SoC(s) 904 may include one or more processor(s) 910 (e.g., embedded processors). The processor(s) 910 may include a boot and power management processor that may be a dedicated processor and subsystem to handle boot power and management functions and related security enforcement. The boot and power management processor may be a part of the SoC(s) 904 boot sequence and may provide runtime power management services. The boot power and management processor may provide clock and voltage programming, assistance in system low power state transitions, management of SoC(s) 904 thermals and temperature sensors, and/or management of the SoC(s) 904 power states. Each temperature sensor may be implemented as a ring-oscillator whose output frequency is proportional to temperature, and the SoC(s) 904 may use the ring-oscillators to detect temperatures of the CPU(s) 906, GPU(s) 908, and/or accelerator(s) 914. If temperatures are determined to exceed a threshold, the boot and power management processor may enter a temperature fault routine and put the SoC(s) 904 into a lower power state and/or put the vehicle 900 into a chauffeur to safe stop mode (e.g., bring the vehicle 900 to a safe stop).

The processor(s) 910 may further include a set of embedded processors that may serve as an audio processing engine. The audio processing engine may be an audio subsystem that enables full hardware support for multi-channel audio over multiple interfaces, and a broad and flexible range of audio I/O interfaces. In some examples, the audio processing engine is a dedicated processor core with a digital signal processor with dedicated RAM.

The processor(s) 910 may further include an always on processor engine that may provide necessary hardware features to support low power sensor management and wake use cases. The always on processor engine may include a processor core, a tightly coupled RAM, supporting peripherals (e.g., timers and interrupt controllers), various I/O controller peripherals, and routing logic.

The processor(s) 910 may further include a safety cluster engine that includes a dedicated processor subsystem to handle safety management for automotive applications. The safety cluster engine may include two or more processor cores, a tightly coupled RAM, support peripherals (e.g., timers, an interrupt controller, etc.), and/or routing logic. In a safety mode, the two or more cores may operate in a lockstep mode and function as a single core with comparison logic to detect any differences between their operations.

The processor(s) 910 may further include a real-time camera engine that may include a dedicated processor subsystem for handling real-time camera management.

The processor(s) 910 may further include a high-dynamic range signal processor that may include an image signal processor that is a hardware engine that is part of the camera processing pipeline.

The processor(s) 910 may include a video image compositor that may be a processing block (e.g., implemented on a microprocessor) that implements video post-processing functions needed by a video playback application to produce the final image for the player window. The video image compositor may perform lens distortion correction on wide-view camera(s) 970, surround camera(s) 974, and/or on in-cabin monitoring camera sensors. In-cabin monitoring camera sensor is preferably monitored by a neural network running on another instance of the Advanced SoC, configured to identify in cabin events and respond accordingly. An in-cabin system may perform lip reading to activate cellular service and place a phone call, dictate emails, change the vehicle's destination, activate or change the vehicle's infotainment system and settings, or provide voice-activated web surfing. Certain functions are available to the driver only when the vehicle is operating in an autonomous mode, and are disabled otherwise.

The video image compositor may include enhanced temporal noise reduction for both spatial and temporal noise reduction. For example, where motion occurs in a video, the noise reduction weights spatial information appropriately, decreasing the weight of information provided by adjacent frames. Where an image or portion of an image does not include motion, the temporal noise reduction performed by the video image compositor may use information from the previous image to reduce noise in the current image.

The video image compositor may also be configured to perform stereo rectification on input stereo lens frames. The video image compositor may further be used for user interface composition when the operating system desktop is in use, and the GPU(s) 908 is not required to continuously render new surfaces. Even when the GPU(s) 908 is powered on and active doing 3D rendering, the video image compositor may be used to offload the GPU(s) 908 to improve performance and responsiveness.

The SoC(s) 904 may further include a mobile industry processor interface (MIPI) camera serial interface for receiving video and input from cameras, a high-speed interface, and/or a video input block that may be used for camera and related pixel input functions. The SoC(s) 904 may further include an input/output controller(s) that may be controlled by software and may be used for receiving I/O signals that are uncommitted to a specific role.

The SoC(s) 904 may further include a broad range of peripheral interfaces to allow communication with peripherals, audio codecs, power management, and/or other devices. The SoC(s) 904 may be used to process data from cameras (e.g., connected over Gigabit Multimedia Serial Link and Ethernet), sensors (e.g., LiDAR sensor(s) 964, RADAR sensor(s) 960, etc. that may be connected over Ethernet), data from bus 902 (e.g., speed of vehicle 900, steering wheel position, etc.), data from GNSS sensor(s) 958 (e.g., connected over Ethernet or CAN bus). The SoC(s) 904 may further include dedicated high-performance mass storage controllers that may include their own DMA engines, and that may be used to free the CPU(s) 906 from routine data management tasks.

The SoC(s) 904 may be an end-to-end platform with a flexible architecture that spans automation levels 3-5, thereby providing a comprehensive functional safety architecture that leverages and makes efficient use of computer vision and ADAS techniques for diversity and redundancy, provides a platform for a flexible, reliable driving software stack, along with deep learning tools. The SoC(s) 904 may be faster, more reliable, and even more energy-efficient and space-efficient than conventional systems. For example, the accelerator(s) 914, when combined with the CPU(s) 906, the GPU(s) 908, and the data store(s) 916, may provide for a fast, efficient platform for level 3-5 autonomous vehicles.

The technology thus provides capabilities and functionality that cannot be achieved by conventional systems. For example, computer vision algorithms may be executed on CPUs, which may be configured using high-level programming language, such as the C programming language, to execute a wide variety of processing algorithms across a wide variety of visual data. However, CPUs are oftentimes unable to meet the performance requirements of many computer vision applications, such as those related to execution time and power consumption, for example. In particular, many CPUs are unable to execute complex object detection algorithms in real-time, which is a requirement of in-vehicle ADAS applications, and a requirement for practical Level 3-5 autonomous vehicles.

In contrast to conventional systems, by providing a CPU complex, GPU complex, and a hardware acceleration cluster, the technology described herein allows for multiple neural networks to be performed simultaneously and/or sequentially, and for the results to be combined together to allow Level 3-5 autonomous driving functionality. For example, a CNN executing on the DLA or dGPU (e.g., the GPU(s) 920) may include a text and word recognition, allowing the supercomputer to read and understand traffic signs, including signs for which the neural network has not been specifically trained. The DLA may further include a neural network that is able to identify, interpret, and provides semantic understanding of the sign, and to pass that semantic understanding to the path planning modules running on the CPU Complex.

As another example, multiple neural networks may be run simultaneously, as is required for Level 3, 4, or 5 driving. For example, a warning sign consisting of “Caution: flashing lights indicate icy conditions,” along with an electric light, may be independently or collectively interpreted by several neural networks. The sign itself may be identified as a traffic sign by a first deployed neural network (e.g., a neural network that has been trained), the text “Flashing lights indicate icy conditions” may be interpreted by a second deployed neural network, which informs the vehicle's path planning software (preferably executing on the CPU Complex) that when flashing lights are detected, icy conditions exist. The flashing light may be identified by operating a third deployed neural network over multiple frames, informing the vehicle's path-planning software of the presence (or absence) of flashing lights. All three neural networks may run simultaneously, such as within the DLA and/or on the GPU(s) 908.

In some examples, a CNN for facial recognition and vehicle owner identification may use data from camera sensors to identify the presence of an authorized driver and/or owner of the vehicle 900. The always on sensor processing engine may be used to unlock the vehicle when the owner approaches the driver door and turn on the lights, and, in security mode, to disable the vehicle when the owner leaves the vehicle. In this way, the SoC(s) 904 provide for security against theft and/or carjacking.

In another example, a CNN for emergency vehicle detection and identification may use data from microphones 996 to detect and identify emergency vehicle sirens. In contrast to conventional systems, that use general classifiers to detect sirens and manually extract features, the SoC(s) 904 use the CNN for classifying environmental and urban sounds, as well as classifying visual data. In a preferred embodiment, the CNN running on the DLA is trained to identify the relative closing speed of the emergency vehicle (e.g., by using the Doppler Effect). The CNN may also be trained to identify emergency vehicles specific to the local area in which the vehicle is operating, as identified by GNSS sensor(s) 958. Thus, for example, when operating in Europe the CNN will seek to detect European sirens, and when in the United States the CNN will seek to identify only North American sirens. Once an emergency vehicle is detected, a control program may be used to execute an emergency vehicle safety routine, slowing the vehicle, pulling over to the side of the road, parking the vehicle, and/or idling the vehicle, with the assistance of ultrasonic sensors 962, until the emergency vehicle(s) passes.

The vehicle may include a CPU(s) 918 (e.g., discrete CPU(s), or dCPU(s)), that may be coupled to the SoC(s) 904 via a high-speed interconnect (e.g., PCIe). The CPU(s) 918 may include an X86 processor, for example. The CPU(s) 918 may be used to perform any of a variety of functions, including arbitrating potentially inconsistent results between ADAS sensors and the SoC(s) 904, and/or monitoring the status and health of the controller(s) 936 and/or infotainment SoC 930, for example.

The vehicle 900 may include a GPU(s) 920 (e.g., discrete GPU(s), or dGPU(s)), that may be coupled to the SoC(s) 904 via a high-speed interconnect (e.g., NVIDIA's NVLINK). The GPU(s) 920 may provide additional artificial intelligence functionality, such as by executing redundant and/or different neural networks, and may be used to train and/or update neural networks based on input (e.g., sensor data) from sensors of the vehicle 900.

The vehicle 900 may further include the network interface 924 which may include one or more wireless antennas 926 (e.g., one or more wireless antennas for different communication protocols, such as a cellular antenna, a Bluetooth antenna, etc.). The network interface 924 may be used to allow wireless connectivity over the Internet with the cloud (e.g., with the server(s) 978 and/or other network devices), with other vehicles, and/or with computing devices (e.g., client devices of passengers). To communicate with other vehicles, a direct link may be established between the two vehicles and/or an indirect link may be established (e.g., across networks and over the Internet). Direct links may be provided using a vehicle-to-vehicle communication link. The vehicle-to-vehicle communication link may provide the vehicle 900 information about vehicles in proximity to the vehicle 900 (e.g., vehicles in front of, on the side of, and/or behind the vehicle 900). This functionality may be part of a cooperative adaptive cruise control functionality of the vehicle 900.

The network interface 924 may include a SoC that provides modulation and demodulation functionality and enables the controller(s) 936 to communicate over wireless networks. The network interface 924 may include a radio frequency front-end for up-conversion from baseband to radio frequency, and down conversion from radio frequency to baseband. The frequency conversions may be performed through well-known processes, and/or may be performed using super-heterodyne processes. In some examples, the radio frequency front end functionality may be provided by a separate chip. The network interface may include wireless functionality for communicating over LTE, WCDMA, UMTS, GSM, CDMA2000, Bluetooth, Bluetooth LE, Wi-Fi, Z-Wave, ZigBee, LoRaWAN, and/or other wireless protocols.

The vehicle 900 may further include data store(s) 928 which may include off-chip (e.g., off the SoC(s) 904) storage. The data store(s) 928 may include one or more storage elements including RAM, SRAM, DRAM, VRAM, Flash, hard disks, and/or other components and/or devices that may store at least one bit of data.

The vehicle 900 may further include GNSS sensor(s) 958. The GNSS sensor(s) 958 (e.g., GPS, assisted GPS sensors, differential GPS (DGPS) sensors, etc.), to assist in mapping, perception, occupancy grid generation, and/or path planning functions. Any number of GNSS sensor(s) 958 may be used, including, for example and without limitation, a GPS using a USB connector with an Ethernet to Serial (RS-232) bridge.

The vehicle 900 may further include RADAR sensor(s) 960. The RADAR sensor(s) 960 may be used by the vehicle 900 for long-range vehicle detection, even in darkness and/or severe weather conditions. RADAR functional safety levels may be ASIL B. The RADAR sensor(s) 960 may use the CAN and/or the bus 902 (e.g., to transmit data generated using the RADAR sensor(s) 960) for control and to access object tracking data, with access to Ethernet to access raw data in some examples. A wide variety of RADAR sensor types may be used. For example, and without limitation, the RADAR sensor(s) 960 may be suitable for front, rear, and side RADAR use. In some example, Pulse Doppler RADAR sensor(s) are used.

The RADAR sensor(s) 960 may include different configurations, such as long range with narrow field of view, short range with wide field of view, short range side coverage, etc. In some examples, long-range RADAR may be used for adaptive cruise control functionality. The long-range RADAR systems may provide a broad field of view realized by two or more independent scans, such as within a 250 m range. The RADAR sensor(s) 960 may help in distinguishing between static and moving objects, and may be used by ADAS systems for emergency brake assist and forward collision warning. Long-range RADAR sensors may include monostatic multimodal RADAR with multiple (e.g., six or more) fixed RADAR antennae and a high-speed CAN and FlexRay interface. In an example with six antennae, the central four antennae may create a focused beam pattern, designed to record the vehicle's 900 surroundings at higher speeds with minimal interference from traffic in adjacent lanes. The other two antennae may expand the field of view, making it possible to quickly detect vehicles entering or leaving the vehicle's 900 lane.

Mid-range RADAR systems may include, as an example, a range of up to 960 m (front) or 80 m (rear), and a field of view of up to 42 degrees (front) or 950 degrees (rear). Short-range RADAR systems may include, without limitation, RADAR sensors designed to be installed at both ends of the rear bumper. When installed at both ends of the rear bumper, such a RADAR sensor systems may create two beams that constantly monitor the blind spot in the rear and next to the vehicle.

Short-range RADAR systems may be used in an ADAS system for blind spot detection and/or lane change assist.

The vehicle 900 may further include ultrasonic sensor(s) 962. The ultrasonic sensor(s) 962, which may be positioned at the front, back, and/or the sides of the vehicle 900, may be used for park assist and/or to create and update an occupancy grid. A wide variety of ultrasonic sensor(s) 962 may be used, and different ultrasonic sensor(s) 962 may be used for different ranges of detection (e.g., 2.5 m, 4 m). The ultrasonic sensor(s) 962 may operate at functional safety levels of ASIL B.

The vehicle 900 may include LiDAR sensor(s) 964. The LiDAR sensor(s) 964 may be used for object and pedestrian detection, emergency braking, collision avoidance, and/or other functions. The LiDAR sensor(s) 964 may be functional safety level ASIL B. In some examples, the vehicle 900 may include multiple LiDAR sensors 964 (e.g., two, four, six, etc.) that may use Ethernet (e.g., to provide data to a Gigabit Ethernet switch).

In some examples, the LiDAR sensor(s) 964 may be capable of providing a list of objects and their distances for a 360-degree field of view. Commercially available LiDAR sensor(s) 964 may have an advertised range of approximately 900 m, with an accuracy of 2 cm-3 cm, and with support for a 900 Mbps Ethernet connection, for example. In some examples, one or more non-protruding LiDAR sensors 964 may be used. In such examples, the LiDAR sensor(s) 964 may be implemented as a small device that may be embedded into the front, rear, sides, and/or corners of the vehicle 900. The LiDAR sensor(s) 964, in such examples, may provide up to a 120-degree horizontal and 35-degree vertical field-of-view, with a 200 m range even for low-reflectivity objects. Front-mounted LiDAR sensor(s) 964 may be configured for a horizontal field of view between 45 degrees and 135 degrees.

In some examples, LiDAR technologies, such as 3D flash LiDAR, may also be used. 3D Flash LiDAR uses a flash of a laser as a transmission source, to illuminate vehicle surroundings up to approximately 200 m. A flash LiDAR unit includes a receptor, which records the laser pulse transit time and the reflected light on each pixel, which in turn corresponds to the range from the vehicle to the objects. Flash LiDAR may allow for highly accurate and distortion-free images of the surroundings to be generated with every laser flash. In some examples, four flash LiDAR sensors may be deployed, one at each side of the vehicle 900. Available 3D flash LiDAR systems include a solid-state 3D staring array LiDAR camera with no moving parts other than a fan (e.g., a non-scanning LiDAR device). The flash LiDAR device may use a 5 nanosecond class I (eye-safe) laser pulse per frame and may capture the reflected laser light in the form of 3D range point clouds and co-registered intensity data. By using flash LiDAR, and because flash LiDAR is a solid-state device with no moving parts, the LiDAR sensor(s) 964 may be less susceptible to motion blur, vibration, and/or shock.

The vehicle may further include IMU sensor(s) 966. The IMU sensor(s) 966 may be located at a center of the rear axle of the vehicle 900, in some examples. The IMU sensor(s) 966 may include, for example and without limitation, an accelerometer(s), a magnetometer(s), a gyroscope(s), a magnetic compass(es), and/or other sensor types. In some examples, such as in six-axis applications, the IMU sensor(s) 966 may include accelerometers and gyroscopes, while in nine-axis applications, the IMU sensor(s) 966 may include accelerometers, gyroscopes, and magnetometers.

In some embodiments, the IMU sensor(s) 966 may be implemented as a miniature, high performance GPS-Aided Inertial Navigation System (GPS/INS) that combines micro-electro-mechanical systems (MEMS) inertial sensors, a high-sensitivity GPS receiver, and advanced Kalman filtering algorithms to provide estimates of position, velocity, and attitude. As such, in some examples, the IMU sensor(s) 966 may allow the vehicle 900 to estimate heading without requiring input from a magnetic sensor by directly observing and correlating the changes in velocity from GPS to the IMU sensor(s) 966. In some examples, the IMU sensor(s) 966 and the GNSS sensor(s) 958 may be combined in a single integrated unit.

The vehicle may include microphone(s) 996 placed in and/or around the vehicle 900. The microphone(s) 996 may be used for emergency vehicle detection and identification, among other things.

The vehicle may further include any number of camera types, including stereo camera(s) 968, wide-view camera(s) 970, infrared camera(s) 972, surround camera(s) 974, long-range and/or mid-range camera(s) 998, and/or other camera types. The cameras may be used to capture image data around an entire periphery of the vehicle 900. The types of cameras used depends on the embodiments and requirements for the vehicle 900, and any combination of camera types may be used to provide the necessary coverage around the vehicle 900. In addition, the number of cameras may differ depending on the embodiment. For example, the vehicle may include six cameras, seven cameras, ten cameras, twelve cameras, and/or another number of cameras. The cameras may support, as an example and without limitation, Gigabit Multimedia Serial Link (GMSL) and/or Gigabit Ethernet. Each of the camera(s) is described with more detail herein with respect to FIG. 9A and FIG. 9B.

The vehicle 900 may further include vibration sensor(s) 942. The vibration sensor(s) 942 may measure vibrations of components of the vehicle, such as the axle(s). For example, changes in vibrations may indicate a change in road surfaces. In another example, when two or more vibration sensors 942 are used, the differences between the vibrations may be used to determine friction or slippage of the road surface (e.g., when the difference in vibration is between a power-driven axle and a freely rotating axle).

The vehicle 900 may include an ADAS system 938. The ADAS system 938 may include a SoC, in some examples. The ADAS system 938 may include autonomous/adaptive/automatic cruise control (ACC), cooperative adaptive cruise control (CACC), forward crash warning (FCW), automatic emergency braking (AEB), lane departure warnings (LDW), lane keep assist (LKA), blind spot warning (BSW), rear cross-traffic warning (RCTW), collision warning systems (CWS), lane centering (LC), and/or other features and functionality.

The ACC systems may use RADAR sensor(s) 960, LiDAR sensor(s) 964, and/or a camera(s). The ACC systems may include longitudinal ACC and/or lateral ACC. Longitudinal ACC monitors and controls the distance to the vehicle immediately ahead of the vehicle 900 and automatically adjust the vehicle speed to maintain a safe distance from vehicles ahead. Lateral ACC performs distance keeping, and advises the vehicle 900 to change lanes when necessary. Lateral ACC is related to other ADAS applications such as LCA and CWS.

CACC uses information from other vehicles that may be received via the network interface 924 and/or the wireless antenna(s) 926 from other vehicles via a wireless link, or indirectly, over a network connection (e.g., over the Internet). Direct links may be provided by a vehicle-to-vehicle (V2V) communication link, while indirect links may be infrastructure-to-vehicle (I2V) communication link. In general, the V2V communication concept provides information about the immediately preceding vehicles (e.g., vehicles immediately ahead of and in the same lane as the vehicle 900), while the I2V communication concept provides information about traffic further ahead. CACC systems may include either or both I2V and V2V information sources. Given the information of the vehicles ahead of the vehicle 900, CACC may be more reliable and it has potential to improve traffic flow smoothness and reduce congestion on the road.

FCW systems are designed to alert the driver to a hazard, so that the driver may take corrective action. FCW systems use a front-facing camera and/or RADAR sensor(s) 960, coupled to a dedicated processor, DSP, FPGA, and/or ASIC, that is electrically coupled to driver feedback, such as a display, speaker, and/or vibrating component. FCW systems may provide a warning, such as in the form of a sound, visual warning, vibration and/or a quick brake pulse.

AEB systems detect an impending forward collision with another vehicle or other object, and may automatically apply the brakes if the driver does not take corrective action within a specified time or distance parameter. AEB systems may use front-facing camera(s) and/or RADAR sensor(s) 960, coupled to a dedicated processor, DSP, FPGA, and/or ASIC. When the AEB system detects a hazard, it typically first alerts the driver to take corrective action to avoid the collision and, if the driver does not take corrective action, the AEB system may automatically apply the brakes in an effort to prevent, or at least mitigate, the impact of the predicted collision. AEB systems, may include techniques such as dynamic brake support and/or crash imminent braking.

LDW systems provide visual, audible, and/or tactile warnings, such as steering wheel or seat vibrations, to alert the driver when the vehicle 900 crosses lane markings. A LDW system does not activate when the driver indicates an intentional lane departure, by activating a turn signal. LDW systems may use front-side facing cameras, coupled to a dedicated processor, DSP, FPGA, and/or ASIC, that is electrically coupled to driver feedback, such as a display, speaker, and/or vibrating component.

LKA systems are a variation of LDW systems. LKA systems provide steering input or braking to correct the vehicle 900 if the vehicle 900 starts to exit the lane.

BSW systems detects and warn the driver of vehicles in an automobile's blind spot. BSW systems may provide a visual, audible, and/or tactile alert to indicate that merging or changing lanes is unsafe. The system may provide an additional warning when the driver uses a turn signal. BSW systems may use rear-side facing camera(s) and/or RADAR sensor(s) 960, coupled to a dedicated processor, DSP, FPGA, and/or ASIC, that is electrically coupled to driver feedback, such as a display, speaker, and/or vibrating component.

RCTW systems may provide visual, audible, and/or tactile notification when an object is detected outside the rear-camera range when the vehicle 900 is backing up. Some RCTW systems include AEB to ensure that the vehicle brakes are applied to avoid a crash. RCTW systems may use one or more rear-facing RADAR sensor(s) 960, coupled to a dedicated processor, DSP, FPGA, and/or ASIC, that is electrically coupled to driver feedback, such as a display, speaker, and/or vibrating component.

Conventional ADAS systems may be prone to false positive results which may be annoying and distracting to a driver, but typically are not catastrophic, because the ADAS systems alert the driver and allow the driver to decide whether a safety condition truly exists and act accordingly. However, in an autonomous vehicle 900, the vehicle 900 itself must, in the case of conflicting results, decide whether to heed the result from a primary computer or a secondary computer (e.g., a first controller 936 or a second controller 936). For example, in some embodiments, the ADAS system 938 may be a backup and/or secondary computer for providing perception information to a backup computer rationality module. The backup computer rationality monitor may run a redundant diverse software on hardware components to detect faults in perception and dynamic driving tasks. Outputs from the ADAS system 938 may be provided to a supervisory MCU. If outputs from the primary computer and the secondary computer conflict, the supervisory MCU must determine how to reconcile the conflict to ensure safe operation.

In some examples, the primary computer may be configured to provide the supervisory MCU with a confidence score, indicating the primary computer's confidence in the chosen result. If the confidence score exceeds a threshold, the supervisory MCU may follow the primary computer's direction, regardless of whether the secondary computer provides a conflicting or inconsistent result. Where the confidence score does not meet the threshold, and where the primary and secondary computer indicate different results (e.g., the conflict), the supervisory MCU may arbitrate between the computers to determine the appropriate outcome.

The supervisory MCU may be configured to run a neural network(s) that is trained and configured to determine, based on outputs from the primary computer and the secondary computer, conditions under which the secondary computer provides false alarms. Thus, the neural network(s) in the supervisory MCU may learn when the secondary computer's output may be trusted, and when it cannot. For example, when the secondary computer is a RADAR-based FCW system, a neural network(s) in the supervisory MCU may learn when the FCW system is identifying metallic objects that are not, in fact, hazards, such as a drainage grate or manhole cover that triggers an alarm. Similarly, when the secondary computer is a camera-based LDW system, a neural network in the supervisory MCU may learn to override the LDW when bicyclists or pedestrians are present and a lane departure is, in fact, the safest maneuver. In embodiments that include a neural network(s) running on the supervisory MCU, the supervisory MCU may include at least one of a DLA or GPU suitable for running the neural network(s) with associated memory. In preferred embodiments, the supervisory MCU may comprise and/or be included as a component of the SoC(s) 904.

In other examples, ADAS system 938 may include a secondary computer that performs ADAS functionality using traditional rules of computer vision. As such, the secondary computer may use classic computer vision rules (if-then), and the presence of a neural network(s) in the supervisory MCU may improve reliability, safety and performance. For example, the diverse implementation and intentional non-identity makes the overall system more fault-tolerant, especially to faults caused by software (or software-hardware interface) functionality. For example, if there is a software bug or error in the software running on the primary computer, and the non-identical software code running on the secondary computer provides the same overall result, the supervisory MCU may have greater confidence that the overall result is correct, and the bug in software or hardware on primary computer is not causing material error.

In some examples, the output of the ADAS system 938 may be fed into the primary computer's perception block and/or the primary computer's dynamic driving task block. For example, if the ADAS system 938 indicates a forward crash warning due to an object immediately ahead, the perception block may use this information when identifying objects. In other examples, the secondary computer may have its own neural network which is trained and thus reduces the risk of false positives, as described herein.

The vehicle 900 may further include the infotainment SoC 930 (e.g., an in-vehicle infotainment system (IVI)). Although illustrated and described as a SoC, the infotainment system may not be a SoC, and may include two or more discrete components. The infotainment SoC 930 may include a combination of hardware and software that may be used to provide audio (e.g., music, a personal digital assistant, navigational instructions, news, radio, etc.), video (e.g., TV, movies, streaming, etc.), phone (e.g., hands-free calling), network connectivity (e.g., LTE, Wi-Fi, etc.), and/or information services (e.g., navigation systems, rear-parking assistance, a radio data system, vehicle related information such as fuel level, total distance covered, brake fuel level, oil level, door open/close, air filter information, etc.) to the vehicle 900. For example, the infotainment SoC 930 may radios, disk players, navigation systems, video players, USB and Bluetooth connectivity, carputers, in-car entertainment, Wi-Fi, steering wheel audio controls, hands free voice control, a heads-up display (HUD), an HMI display 934, a telematics device, a control panel (e.g., for controlling and/or interacting with various components, features, and/or systems), and/or other components. The infotainment SoC 930 may further be used to provide information (e.g., visual and/or audible) to a user(s) of the vehicle, such as information from the ADAS system 938, autonomous driving information such as planned vehicle maneuvers, trajectories, surrounding environment information (e.g., intersection information, vehicle information, road information, etc.), and/or other information.

The infotainment SoC 930 may include GPU functionality. The infotainment SoC 930 may communicate over the bus 902 (e.g., CAN bus, Ethernet, etc.) with other devices, systems, and/or components of the vehicle 900. In some examples, the infotainment SoC 930 may be coupled to a supervisory MCU such that the GPU of the infotainment system may perform some self-driving functions in the event that the primary controller(s) 936 (e.g., the primary and/or backup computers of the vehicle 900) fail. In such an example, the infotainment SoC 930 may put the vehicle 900 into a chauffeur to safe stop mode, as described herein.

The vehicle 900 may further include an instrument cluster 932 (e.g., a digital dash, an electronic instrument cluster, a digital instrument panel, etc.). The instrument cluster 932 may include a controller and/or supercomputer (e.g., a discrete controller or supercomputer). The instrument cluster 932 may include a set of instrumentation such as a speedometer, fuel level, oil pressure, tachometer, odometer, turn indicators, gearshift position indicator, seat belt warning light(s), parking-brake warning light(s), engine-malfunction light(s), airbag (SRS) system information, lighting controls, safety system controls, navigation information, etc. In some examples, information may be displayed and/or shared among the infotainment SoC 930 and the instrument cluster 932. As such, the instrument cluster 932 may be included as part of the infotainment SoC 930, or vice versa.

FIG. 9D is a system diagram for communication between cloud-based server(s) and the example autonomous vehicle 900 of FIG. 9A, in accordance with some embodiments of the present disclosure. The system 976 may include server(s) 978, network(s) 990, and vehicles, including the vehicle 900. The server(s) 978 may include a plurality of GPUs 984(A)-984(H) (collectively referred to herein as GPUs 984), PCIe switches 982(A)-982(D) (collectively referred to herein as PCIe switches 982), and/or CPUs 980(A)-980(B) (collectively referred to herein as CPUs 980). The GPUs 984, the CPUs 980, and the PCIe switches may be interconnected with high-speed interconnects such as, for example and without limitation, NVLink interfaces 988 developed by NVIDIA and/or PCIe connections 986. In some examples, the GPUs 984 are connected via NVLink and/or NVSwitch SoC and the GPUs 984 and the PCIe switches 982 are connected via PCIe interconnects. Although eight GPUs 984, two CPUs 980, and two PCIe switches are illustrated, this is not intended to be limiting. Depending on the embodiment, each of the server(s) 978 may include any number of GPUs 984, CPUs 980, and/or PCIe switches. For example, the server(s) 978 may each include eight, sixteen, thirty-two, and/or more GPUs 984.

The server(s) 978 may receive, over the network(s) 990 and from the vehicles, image data representative of images showing unexpected or changed road conditions, such as recently commenced road-work. The server(s) 978 may transmit, over the network(s) 990 and to the vehicles, neural networks 992, updated neural networks 992, and/or map information 994, including information regarding traffic and road conditions. The updates to the map information 994 may include updates for the HD map 922, such as information regarding construction sites, potholes, detours, flooding, and/or other obstructions. In some examples, the neural networks 992, the updated neural networks 992, and/or the map information 994 may have resulted from new training and/or experiences represented in data received from any number of vehicles in the environment, and/or based on training performed at a datacenter (e.g., using the server(s) 978 and/or other servers).

The server(s) 978 may be used to train machine learning models (e.g., neural networks) based on training data. The training data may be generated using the vehicles, and/or may be generated in a simulation (e.g., using a game engine). In some examples, the training data is tagged (e.g., where the neural network benefits from supervised learning) and/or undergoes other pre-processing, while in other examples the training data is not tagged and/or pre-processed (e.g., where the neural network does not require supervised learning). Training may be executed according to any one or more classes of machine learning techniques, including, without limitation, classes such as: supervised training, semi-supervised training, unsupervised training, self-learning, reinforcement learning, federated learning, transfer learning, feature learning (including principal component and cluster analyses), multi-linear subspace learning, manifold learning, representation learning (including spare dictionary learning), rule-based machine learning, anomaly detection, and any variants or combinations therefor. Once the machine learning models are trained, the machine learning models may be used by the vehicles (e.g., transmitted to the vehicles over the network(s) 990, and/or the machine learning models may be used by the server(s) 978 to remotely monitor the vehicles. In some embodiments, a stereo depth perception model 120 as described herein may be training using server(s) 978.

In some examples, the server(s) 978 may receive data from the vehicles and apply the data to up-to-date real-time neural networks for real-time intelligent inferencing. The server(s) 978 may include deep-learning supercomputers and/or dedicated AI computers powered by GPU(s) 984, such as a DGX and DGX Station machines developed by NVIDIA. However, in some examples, the server(s) 978 may include deep learning infrastructure that use only CPU-powered datacenters.

The deep-learning infrastructure of the server(s) 978 may be capable of fast, real-time inferencing, and may use that capability to evaluate and verify the health of the processors, software, and/or associated hardware in the vehicle 900. For example, the deep-learning infrastructure may receive periodic updates from the vehicle 900, such as a sequence of images and/or objects that the vehicle 900 has located in that sequence of images (e.g., via computer vision and/or other machine learning object classification techniques). The deep-learning infrastructure may run its own neural network to identify the objects and compare them with the objects identified by the vehicle 900 and, if the results do not match and the infrastructure concludes that the AI in the vehicle 900 is malfunctioning, the server(s) 978 may transmit a signal to the vehicle 900 instructing a fail-safe computer of the vehicle 900 to assume control, notify the passengers, and complete a safe parking maneuver.

For inferencing, the server(s) 978 may include the GPU(s) 984 and one or more programmable inference accelerators (e.g., NVIDIA's TensorRT). The combination of GPU-powered servers and inference acceleration may make real-time responsiveness possible. In other examples, such as where performance is less critical, servers powered by CPUs, FPGAs, and other processors may be used for inferencing.

### Example Computing Device

FIG. 10 is a block diagram of an example computing device(s) 1000 suitable for use in implementing some embodiments of the present disclosure. Computing device 1000 may include an interconnect system 1002 that directly or indirectly couples the following devices: memory 1004, one or more central processing units (CPUs) 1006, one or more graphics processing units (GPUs) 1008, a communication interface 1010, input/output (I/O) ports 1012, input/output components 1014, a power supply 1016, one or more presentation components 1018 (e.g., display(s)), and one or more logic units 1020. In at least one embodiment, the computing device(s) 1000 may comprise one or more virtual machines (VMs), and/or any of the components thereof may comprise virtual components (e.g., virtual hardware components). For non-limiting examples, one or more of the GPUs 1008 may comprise one or more vGPUs, one or more of the CPUs 1006 may comprise one or more vCPUs, and/or one or more of the logic units 1020 may comprise one or more virtual logic units. As such, a computing device(s) 1000 may include discrete components (e.g., a full GPU dedicated to the computing device 1000), virtual components (e.g., a portion of a GPU dedicated to the computing device 1000), or a combination thereof. In some embodiments, one or more functions of the depth image anomaly processor 130, depth image anomaly identification data 132 and/or depth image anomaly correction state 134 may be implemented at least in part using computing device(s) 1000.

Although the various blocks of FIG. 10 are shown as connected via the interconnect system 1002 with lines, this is not intended to be limiting and is for clarity only. For example, in some embodiments, a presentation component 1018, such as a display device, may be considered an I/O component 1014 (e.g., if the display is a touch screen). As another example, the CPUs 1006 and/or GPUs 1008 may include memory (e.g., the memory 1004 may be representative of a storage device in addition to the memory of the GPUs 1008, the CPUs 1006, and/or other components). As such, the computing device of FIG. 10 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 10.

In some embodiments, one or more functions of the depth image anomaly processor 130, depth image anomaly identification data 132 and/or depth image anomaly correction state 134 may be implemented at least in part by code executing on CPUs 1006 and/or GPUs 1008.

The interconnect system 1002 may represent one or more links or busses, such as an address bus, a data bus, a control bus, or a combination thereof. The interconnect system 1002 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 1006 may be directly connected to the memory 1004. Further, the CPU 1006 may be directly connected to the GPU 1008. Where there is direct, or point-to-point connection between components, the interconnect system 1002 may include a PCIe link to carry out the connection. In these examples, a PCI bus need not be included in the computing device 1000.

The memory 1004 may include any of a variety of computer-readable media. The computer-readable media may be any available media that may be accessed by the computing device 1000. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 1004 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 1000. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 1006 may be configured to execute at least some of the computer-readable instructions to control one or more components of the computing device 1000 to perform one or more of the methods and/or processes described herein. The CPU(s) 1006 may each include one or more cores (e.g., one, two, four, eight, twenty-eight, seventy-two, etc.) that are capable of handling a multitude of software threads simultaneously. The CPU(s) 1006 may include any type of processor, and may include different types of processors depending on the type of computing device 1000 implemented (e.g., processors with fewer cores for mobile devices and processors with more cores for servers). For example, depending on the type of computing device 1000, the processor may be an Advanced RISC Machines (ARM) processor implemented using Reduced Instruction Set Computing (RISC) or an x86 processor implemented using Complex Instruction Set Computing (CISC). The computing device 1000 may include one or more CPUs 1006 in addition to one or more microprocessors or supplementary co-processors, such as math co-processors.

In addition to or alternatively from the CPU(s) 1006, the GPU(s) 1008 may be configured to execute at least some of the computer-readable instructions to control one or more components of the computing device 1000 to perform one or more of the methods and/or processes described herein. One or more of the GPU(s) 1008 may be an integrated GPU (e.g., with one or more of the CPU(s) 1006 and/or one or more of the GPU(s) 1008 may be a discrete GPU. In embodiments, one or more of the GPU(s) 1008 may be a coprocessor of one or more of the CPU(s) 1006. The GPU(s) 1008 may be used by the computing device 1000 to render graphics (e.g., 3D graphics) or perform general purpose computations. For example, the GPU(s) 1008 may be used for General-Purpose computing on GPUs (GPGPU). The GPU(s) 1008 may include hundreds or thousands of cores that are capable of handling hundreds or thousands of software threads simultaneously. The GPU(s) 1008 may generate pixel data for output images in response to rendering commands (e.g., rendering commands from the CPU(s) 1006 received via a host interface). The GPU(s) 1008 may include graphics memory, such as display memory, for storing pixel data or any other suitable data, such as GPGPU data. The display memory may be included as part of the memory 1004. The GPU(s) 1008 may include two or more GPUs operating in parallel (e.g., via a link). The link may directly connect the GPUs (e.g., using NVLINK) or may connect the GPUs through a switch (e.g., using NVSwitch). When combined together, each GPU 1008 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 1006 and/or the GPU(s) 1008, the logic unit(s) 1020 may be configured to execute at least some of the computer-readable instructions to control one or more components of the computing device 1000 to perform one or more of the methods and/or processes described herein. In embodiments, the CPU(s) 1006, the GPU(s) 1008, and/or the logic unit(s) 1020 may discretely or jointly perform any combination of the methods, processes and/or portions thereof. One or more of the logic units 1020 may be part of and/or integrated in one or more of the CPU(s) 1006 and/or the GPU(s) 1008 and/or one or more of the logic units 1020 may be discrete components or otherwise external to the CPU(s) 1006 and/or the GPU(s) 1008. In embodiments, one or more of the logic units 1020 may be a coprocessor of one or more of the CPU(s) 1006 and/or one or more of the GPU(s) 1008.

Examples of the logic unit(s) 1020 include one or more processing cores and/or components thereof, such as Data Processing Units (DPUs), Tensor Cores (TCs), Tensor Processing Units(TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 1010 may include one or more receivers, transmitters, and/or transceivers that allow the computing device 1000 to communicate with other computing devices via an electronic communication network, included wired and/or wireless communications. The communication interface 1010 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 1020 and/or communication interface 1010 may include one or more data processing units (DPUs) to transmit data received over a network and/or through interconnect system 1002 directly to (e.g., a memory of) one or more GPU(s) 1008.

The I/O ports 1012 may allow the computing device 1000 to be logically coupled to other devices including the I/O components 1014, the presentation component(s) 1018, and/or other components, some of which may be built in to (e.g., integrated in) the computing device 1000. Illustrative I/O components 1014 include a microphone, mouse, keyboard, joystick, game pad, game controller, satellite dish, scanner, printer, wireless device, etc. The I/O components 1014 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1000. The computing device 1000 may be include depth cameras, such as stereoscopic camera systems, infrared camera systems, RGB camera systems, touchscreen technology, and combinations of these, for gesture detection and recognition. Additionally, the computing device 1000 may include accelerometers or gyroscopes (e.g., as part of an inertia measurement unit (IMU)) that allow detection of motion. In some examples, the output of the accelerometers or gyroscopes may be used by the computing device 1000 to render immersive augmented reality or virtual reality.

The power supply 1016 may include a hard-wired power supply, a battery power supply, or a combination thereof. The power supply 1016 may provide power to the computing device 1000 to allow the components of the computing device 1000 to operate.

The presentation component(s) 1018 may include a display (e.g., a monitor, a touch screen, a television screen, a heads-up-display (HUD), other display types, or a combination thereof), speakers, and/or other presentation components. The presentation component(s) 1018 may receive data from other components (e.g., the GPU(s) 1008, the CPU(s) 1006, DPUs, etc.), and output the data (e.g., as an image, video, sound, etc.). In some embodiments, HMI 124 may be implemented by and/or comprise one or more of presentation component(s) 1018.

### Example Data Center

FIG. 11 illustrates an example data center 1100 that may be used in at least one embodiments of the present disclosure. The data center 1100 may include a data center infrastructure layer 1110, a framework layer 1120, a software layer 1130, and/or an application layer 1140.

As shown in FIG. 11, the data center infrastructure layer 1110 may include a resource orchestrator 1112, grouped computing resources 1114, and node computing resources (“node C.R.s”) 1116(1)-1116(N), where “N” represents any whole, positive integer. In at least one embodiment, node C.R.s 1116(1)-1116(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 1116(1)-1116(N) may correspond to a server having one or more of the above-mentioned computing resources. In addition, in some embodiments, the node C.R.s 1116(1)-11161(N) may include one or more virtual components, such as vGPUs, vCPUs, and/or the like, and/or one or more of the node C.R.s 1116(1)-1116(N) may correspond to a virtual machine (VM).

In some embodiments, one or more functions of the depth image anomaly processor 130, depth image anomaly identification data 132 and/or depth image anomaly correction state 134 may be implemented at least in part by code executing on one or more of node C.R.s 1116(1)-1116(N).

In at least one embodiment, grouped computing resources 1114 may include separate groupings of node C.R.s 1116 housed within one or more racks (not shown), or many racks housed in data centers at various geographical locations (also not shown). Separate groupings of node C.R.s 1116 within grouped computing resources 1114 may include grouped compute, network, memory or storage resources that may be configured or allocated to support one or more workloads. In at least one embodiment, several node C.R.s 1116 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1112 may configure or otherwise control one or more node C.R.s 1116(1)-1116(N) and/or grouped computing resources 1114. In at least one embodiment, resource orchestrator 1112 may include a software design infrastructure (SDI) management entity for the data center 1100. The resource orchestrator 1112 may include hardware, software, or some combination thereof.

In at least one embodiment, as shown in FIG. 11, framework layer 1120 may include a job scheduler 1133, a configuration manager 1134, a resource manager 1136, and/or a distributed file system 1138. The framework layer 1120 may include a framework to support software 1132 of software layer 1130 and/or one or more application(s) 1142 of application layer 1140. The software 1132 or application(s) 1142 may respectively include web-based service software or applications, such as those provided by Amazon Web Services, Google Cloud and Microsoft Azure. The framework layer 1120 may be, but is not limited to, a type of free and open-source software web application framework such as Apache Spark™ (hereinafter “Spark”) that may use distributed file system 1138 for large-scale data processing (e.g., “big data”). In at least one embodiment, job scheduler 1133 may include a Spark driver to facilitate scheduling of workloads supported by various layers of data center 1100. The configuration manager 1134 may be capable of configuring different layers such as software layer 1130 and framework layer 1120 including Spark and distributed file system 1138 for supporting large-scale data processing. The resource manager 1136 may be capable of managing clustered or grouped computing resources mapped to or allocated for support of distributed file system 1138 and job scheduler 1133. In at least one embodiment, clustered or grouped computing resources may include grouped computing resource 1114 at data center infrastructure layer 1110. The resource manager 1136 may coordinate with resource orchestrator 1112 to manage these mapped or allocated computing resources.

In some embodiments, one or more functions of the depth image anomaly processor 130, depth image anomaly identification data 132 and/or depth image anomaly correction state 134 may be implemented at least in part using application(s) 1142 and/or software 1132/

In at least one embodiment, software 1132 included in software layer 1130 may include software used by at least portions of node C.R.s 1116(1)-1116(N), grouped computing resources 1114, and/or distributed file system 1138 of framework layer 1120. One or more types of software may include, but are not limited to, Internet web page search software, e-mail virus scan software, database software, and streaming video content software.

In at least one embodiment, application(s) 1142 included in application layer 1140 may include one or more types of applications used by at least portions of node C.R.s 1116(1)-1116(N), grouped computing resources 1114, and/or distributed file system 1138 of framework layer 1120. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1134, resource manager 1136, and resource orchestrator 1112 may implement any number and type of self-modifying actions based on any amount and type of data acquired in any technically feasible fashion. Self-modifying actions may relieve a data center operator of data center 1100 from making possibly bad configuration decisions and possibly avoiding underutilized and/or poor performing portions of a data center.

The data center 1100 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1100. In at least one embodiment, trained or deployed machine learning models corresponding to one or more neural networks may be used to infer or predict information using resources described above with respect to the data center 1100 by using weight parameters calculated through one or more training techniques, such as but not limited to those described herein.

In at least one embodiment, the data center 1100 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 1000 of FIG. 10—e.g., each device may include similar components, features, and/or functionality of the computing device(s) 1000. In addition, where backend devices (e.g., servers, NAS, etc.) are implemented, the backend devices may be included as part of a data center 1100, an example of which is described in more detail herein with respect to FIG. 11.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments - in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 1000 described herein with respect to FIG. 10. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. One or more processors comprising processing circuitry to:
generate a depth image using a machine learning model based at least on an input of image data comprising at least one stereo image pair;
evaluate the depth image to identify at least one segment of one or more anomalous depth values;
classify the at least one segment, in image space, based at least on the identification of the one or more anomalous depth values; and
generate, based at least on the classification of the at least one segment, an updated depth image to include one or more updated depth values in the at least one segment of the updated depth image.

2. The one or more processors of claim 1, the processing circuitry further to:
apply a mask to the at least one segment of the updated depth image to redact the one or more anomalous depth values to output a masked depth image; and
execute one or more operations based at least on the masked depth image.

3. The one or more processors of claim 1, the processing circuitry further to:
identify the at least one segment based at least on a depth value pattern associated with the image space classification of the at least one segment.

4. The one or more processors of claim 1, the processing circuitry further to:
identify the at least one segment based at least on a lighting-based artifact image space classification of the at least one segment.

5. The one or more processors of claim 1, the processing circuitry further to:
identify the at least one segment based at least on identifying one or more depth value discontinuities within the at least one segment.

6. The one or more processors of claim 1, the processing circuitry further to:
determine a quality of the depth image based at least on the at least one segment of one or more anomalous depth values; and
output an accuracy score for the machine learning model based at least on the determined quality.

7. The one or more processors of claim 1, wherein the image space classification includes at least a surface geometry classification.

8. The one or more processors of claim 1, the processing circuitry further to:
identify the at least one segment based at least on an input from a human-machine interface comprising an indication of the at least one segment as comprising the one or more anomalous depth values.

9. The one or more processors of claim 1, wherein the updated depth image is generated based at least on the one or more updated depth values computed for the one or more anomalous depth values.

10. The one or more processors of claim 9, the processing circuitry further to:
compute one or more interpolated depth values for the one or more anomalous depth values based at least on a set of depth values selected from one or more segments of the depth image not identified as comprising the one or more anomalous depth values; and
wherein the one or more updated depth values are based on the one or more interpolated depth values.

11. The one or more processors of claim 10, the processing circuitry further to:
apply the one or more interpolated depth values to a surface-fitting algorithm to compute the one or more updated depth values.

12. The one or more processors of claim 11, the processing circuitry further to:
apply one or more structural constraints to the surface-fitting algorithm based at least on one or more contextual classifications determined from a geometry depicted in the at least one stereo image pair.

13. The one or more processors of claim 12, wherein the one or more structural constraints are defined based at least on a generalized architectural model selected based at least on the geometry depicted in the at least one stereo image pair.

14. The one or more processors of claim 10, the processing circuitry further to:
output a set of data samples that include a data sample comprising the at least one stereo image pair and the corrected depth image.

15. The one or more processors of claim 1, wherein the processing circuitry is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for generating or presenting at least one of virtual reality content, augmented reality content, or mixed reality content;
a system for performing deep learning operations;
a system implemented using an edge device;
a system implemented using a robot;
a system for performing conversational artificial intelligence (AI) operations;
a system implementing one or more language models;
a system implementing one or more large language models (LLMs);
a system implementing one or more vision language models (VLMs);
a system for performing generative AI operations;
a system for generating synthetic data;
a system incorporating one or more virtual machines (VMs);
a system implemented at least partially in a data center; or
a system implemented at least partially using cloud computing resources.

16. A system comprising one or more processors to:
obtain image data comprising at least one stereo image pair; and
generate, using a machine learning model, a depth image based at least on one stereo image pair, wherein the machine learning model is trained to infer the depth image based at least on a feedback loss determined using at least a ground truth depth image, the ground truth depth image generated based at least on:
a corrected depth image comprising one or more corrected depth values, the one or more corrected depth values computed for one or more anomalous depth values identified from a training depth image determined from a training stereo image pair.

17. The system of claim 16, wherein the one or more processors are further to:
determine a quality of the depth image based at least on an identification of at least one segment of the depth image as comprising a set of anomalous depth values; and
output an accuracy score for the machine learning model based at least on the determined quality.

18. The system of claim 16, wherein the one or more processors are further to:
output a set of data samples that include a data sample comprising the at least one stereo image pair and the depth image generated from the at least one stereo image pair.

19. The system of claim 16, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for generating or presenting at least one of virtual reality content, augmented reality content, or mixed reality content;
a system for performing deep learning operations;
a system implemented using an edge device;
a system implemented using a robot;
a system for performing conversational artificial intelligence (AI) operations;
a system implementing one or more language models;
a system implementing one or more large language models (LLMs);
a system implementing one or more vision language models (VLMs);
a system for performing generative AI operations;
a system for generating synthetic data;
a system incorporating one or more virtual machines (VMs);
a system implemented at least partially in a data center; or
a system implemented at least partially using cloud computing resources.

20. A method comprising:
generating a corrected depth image comprising depth information represented by a stereo image pair based at least on evaluating an initial depth image generated by applying the stereo image pair as input to a machine learning model, the evaluating to identify at least one segment of the first depth image comprising one or more anomalous depth values, wherein the at least one segment is identified based at least on an image space classification of the at least one segment.
